(19) United States
(12) Patent Application Publication
(10) Pub. No.: US 2023/0133308 A1
(43) Pub. Date: May 4, 2023

(54) MOUNTING BRACKET ASSEMBLY FOR SOLAR TRACKER ASSEMBLY

(71) Applicant: OMCO SOLAR, LLC, Phoenix, AZ (US)

(72) Inventors: Andrew James Ballentine, San Tan Valley, AZ (US); David J. Wilson, Glendale, AZ (US); Matt Kesler, Phoenix, AZ (US)

(21) Appl. No.: 17/980,405

(22) Filed: Nov. 3, 2022

Related U.S. Application Data
(60) Provisional application No. 63/275,166, filed on Nov. 3, 2021.

(51) Int. Cl. H02S 20/32

(52) U.S. Cl. CPC H02S 20/32; H02S 30/20

(57) ABSTRACT

A mounting bracket assembly mounted to a torque tube beam of a solar tracker assembly and supporting longitudinally extending edge portions of first and second photovoltaic modules, the first set of photovoltaic modules on a first side of the torque tube beam and the second set of photovoltaic modules on an opposite side of the torque tube beam and the longitudinally extending edge portions of the first and second sets of photovoltaic modules extending parallel to the torque tube beam. The mounting bracket assembly includes first and second mounting brackets coupled to the beam. First and second module support members are coupled to and span the first and second mounting brackets. The first module support member includes first and second support arms supporting edge portions of the first photovoltaic module and the second module support member includes third and fourth support arms supporting edge portions of the second photovoltaic module.

### CROSS REFERENCE TO RELATED APPLICATIONS

The following application claims priority under 35 U.S.C. § 119(e) to co-pending U.S. Provisional Patent Application Ser. No. 63/275,166, filed Nov. 3, 2021, entitled Mounting Bracket Assembly For Solar Tracker System. The above-identified U.S. provisional patent application is incorporated by reference herein in its entirety for any and all purposes.

### TECHNICAL FIELD

The present disclosure relates to a mounting bracket assembly for a solar tracker system or assembly and, more specifically, to a mounting bracket assembly secured to a torque tube beam of a solar tracker system and supporting longitudinally extending edge portions of first and second sets of bifacial photovoltaic modules, the first and second sets of bifacial photovoltaic modules being in landscape orientation and positioned on opposite sides of the torque tube beam.

### BACKGROUND

Various types of solar tracker assemblies are known including a horizontal, single axis solar tracker system. Solar tracker assemblies are also sometimes referred to in the industry as solar tracker systems, solar tracker assemblies, solar tracker apparatuses, solar tracking systems, solar tracking assemblies, or solar tracking apparatuses, and such terms are understood to be interchangeable throughout. A horizontal, single axis solar tracker assembly includes a torque tube beam and a plurality of photovoltaic modules, sometimes referred to as solar modules or panels. The plurality of photovoltaic modules is coupled to the torque tube beam via various components including mounting brackets, clamps and fasteners. The torque tube beam is typically comprised of one or more torque tube beam segments affixed in a linear fashion by couplers between adjacent segment ends. The torque tube beam is horizontal in that the torque tube beam extends parallel to the ground. The torque tube beam may be comprised of a plurality of segments of predetermined length, i.e., 40 foot segments. The modules of the plurality of photovoltaic modules are typically spaced uniformly along the torque tube beam. The solar tracker system includes a pivoting table. The solar tracker system table includes everything that pivots or swings about an axis of rotation of the table. The table of the solar tracking assembly typically includes: a) the torque tube beam; b) the plurality of photovoltaic modules; c) the movable or pivoting portions of a plurality of solar tracking bearing apparatuses that support the torque tube along its length; and d) various mounting components, such as module rails, clamps, brackets and/or fasteners, which are used to affix the plurality of photovoltaic modules to the torque tube beam. The axis of rotation of the table of the solar tracker system extends parallel to the torque tube beam and is defined by the axes of rotation of the pivoting portions of a plurality of solar tracking bearing apparatuses. A solar tracking system or assembly may comprise a single row layout, i.e., a single torque tube beam extending in a north-south direction or, alternately, a solar tracking system may comprise an array of solar tracking assemblies comprised of multiple parallel rows of solar tracking assemblies, that is, an array including multiple, spaced apart, parallel rows of torque tube beams, each extending in a north-south direction.

An extent of the table of a solar tracker system or solar tracking assembly extends in two dimensions, length, generally perpendicular to the path or arc of the sun in the sky, and width, generally parallel to the path of sun in the sky. An actuator mechanism, such as a slew drive or linear actuator, operating under the direction of a controller, is coupled to the torque tube beam to pivot or swing the torque tube beam about the axis of rotation to change an angle of inclination of the frame and thereby adjust the light receiving surfaces of the plurality of photovoltaic modules to track the movement of the sun across the sky so that the photovoltaic modules are maximally exposed to the sun throughout the day. That is, the goal of the solar tracker system is to move or pivot the table about an axis of rotation such that the light receiving surfaces of the photovoltaic modules are generally orthogonal to the position of the sun, within, of course, the limits of the angle of inclination range of the table of the solar tracking system.

In one typical embodiment of a horizontal, single axis solar tracker assembly or system, the torque tube beam extends horizontally along the length of the table and, to achieve a proper balance, a plurality of photovoltaic modules are positioned such that each is centered about the torque tube beam so that a total weight of the frame and the plurality of photovoltaic modules, and associated mounting components (e.g., module rails, clamps, brackets and fasteners), is approximately equally distributed on either side of the torque tube beam. A typical photovoltaic module in 1 meter wide by two meters long. Thus, in a so-called portrait orientation of the modules, each module is centered over the torque tube beam such that the shorter sides or extents, that is, the one meter sides (the width), extend along the length of the torque tube beam, while the two meter sides, that is, the longer two meter sides (the length), straddle the torque tube beam such that, when viewed in top plan view, one meter of the module is on one side of the torque tube beam and one meter of the module is on the opposite side of the torque tube beam. This orientation provides for a balanced weight load on both sides of the torque tube beam.

A slew drive or slew gear drive is approximately centered along the length of the torque tube beam and includes first and second journals. A first portion of the torque tube beam is affixed to and extends from the first journal on one side of the slew drive and a second portion of the torque tube beam is affixed to and extends from the second journal on the opposite side of the slew drive. For example, the first portion of the torque tube beam may extend north from the slew drive and may be comprised of five, 40-foot torque tube beam segments, while, the second portion of the torque tube beam may extend south from the slew drive and may similarly be comprised of five, 40-foot torque tube beam segments, thus providing a total north-south extent or length of the torque tube beam of 400 feet. Couplers are used between adjacent torque tube beam segments to splice the two torque tube beam segments together. The slew drive pivots the table of the about the axis of rotation of the table. It should be understood that drives other than a slew drive may be used to pivot the table, for example, one or more electrical linear actuators may be used to pivot the table of the solar tracking system in place of one or more slew gear drives.

The torque tube beam is supported for pivoting movement about the axis of rotation by the plurality of solar tracker bearing apparatuses. Each of the solar tracker bearing apparatuses are affixed to a respective one of a plurality of spaced apart upright support posts which are anchored to or anchored in a substrate, such as the ground. The upright support posts are stationary and support the plurality of solar tracker bearing apparatuses, which, in turn, pivotally support the frame and the plurality of photovoltaic modules. Typically, one solar tracker bearing apparatus is mounted or coupled to each upright support post. Each solar tracker bearing apparatus includes a stationary portion, affixed to a support post, and a rotating portion supporting the torque tube beam, which rotates about the axis of rotation. Additionally, the slew drive is also mounted to its own support post.

The plurality of solar tracker bearing apparatuses pivotally support the torque tube beam for movement or pivoting about the axis of rotation. The actuator mechanism, i.e., the slew drive or linear actuator, coupled to the torque tube beam and operating under the control of a controller, provides the motive force to pivot the table about the axis of rotation and thus change the angle of inclination of the table. The plurality of solar tracker bearing apparatuses rotatably disposed between the torque tube beam and the upright support posts permit the torque tube beam to pivot with respect to the upright support posts and thereby allows the angle of inclination of the table to be changed by the slew drive such that the plurality of photovoltaic modules is maximally exposed to the sun within the range of the angle of inclination of the solar tracking system. The axis of rotation of the table of the solar tracker system is defined by a combination of aligned individual axes of rotation of the individual solar tracker bearing apparatuses. The slew drive is positioned such that it pivots the torque tube beam about the axis of rotation. In a solar tracking system or assembly that includes an array of multiple, spaced apart, parallel rows of torque tube beams, each extending in a north-south direction, each row may include an independent slew drive coupled to the torque tube beam to pivot the table. Alternately, the torque tube beams of multiple rows may be mechanically coupled such that a single, larger slew drive, or another type of drive, may be used to pivot the respective tables of the multiple rows in unison.

Solar tracker assemblies or systems are often erected or installed at remote locations where sun exposure is maximized. As such, the solar tracker assembly components are utilized in outdoor locations, exposed to varying and potentially harsh weather conditions such as high wind and snow conditions. Under high wind load and snow load conditions, the mounting components of the table must be sufficiently strong and stable to mount the photovoltaic modules securely to the torque tube beam and mitigate undue flexing or wiggling of the mounting components and the photovoltaic modules.

A recent trend in single axis solar tracker assemblies is to utilize bifacial photovoltaic modules or panels in the assembly, as contrasted with monofacial photovoltaic modules or panels. Bifacial photovoltaic modules have solar energy cells on both the upper and lower surfaces (or front and back planar surfaces) of the module and are transparent, as contrasted with monofacial photovoltaic modules which have solar energy cells only on one surface of the module. Because a bifacial photovoltaic module includes solar energy cells on both upper and lower surfaces, it advantageously can absorb direct sunlight energy on the upper surface (facing the sun) and indirect sunlight energy on the lower or back surface (facing away from the sun) in the form of reflected or ambient sunlight. Thus, in a bifacial photovoltaic module, solar energy output and efficiency is enhanced by the energy output of the lower surface.

A number of issues result from the use of bifacial photovoltaic modules including orientation and position of the modules. Typically, as noted previously, a single row of photovoltaic panels in a single axis tracker typically are positioned in so-called portrait orientation, centered over the torque tube beam. Such a portrait orientation centered about the torque tube beam is not desirable for bifacial photovoltaic modules, however. Such an orientation and position of bifacial photovoltaic modules would result in the torque tube beam and bearing assemblies shading the lower surfaces of the modules, thus, decreasing solar energy output from the lower surfaces of the bifacial modules. Accordingly, for bifacial photovoltaic modules, it is generally desirable to position and orient the modules, as viewed in top plan view, in two spaced apart rows or sets of photovoltaic modules, one set on one side of the torque tube beam and the second set on the other side of the torque tube beam wherein the modules are in so-called landscape orientation. That is, the longer length or extent of the modules (i.e., the longer two-meter sides of the respective bifacial photovoltaic modules) extend parallel to the torque tube beam. The reason for the spacing between the two sets of modules is that it is desired to avoid, to the extent possible, shading or shadowing of the lower surfaces of the modules by the torque tube beam and bearing assemblies. The spacing and orientation of the two sets of modules, one on each side of the torque tube beam, and being in landscape orientation is that it is desired to both properly balance and minimize the torque required to pivot the table (the table including the torque tube beam, the moving portions of the actuator mechanism, such as a slew drive or linear actuator, the pivoting portions of the bearing assemblies, the mounting bracket assemblies and the two sets of bifacial photovoltaic modules) and to make the configuration less susceptible to twisting or flexing under high wind load and/or snow load conditions.

Additionally, the gap or spacing between the two sets of photovoltaic modules permits accumulated snow to be more readily dumped from the upper surfaces of the modules, than if the two sets of modules were contiguous. When mounting or coupling the two sets of bifacial photovoltaic modules in landscape orientation to the torque tube beam, because of the weight and characteristics of a bifacial photovoltaic modules, it is typically desired to support the modules along their longitudinally extending outer edges, that is, along the outer edges of the longer sides of the bifacial modules that extending along the longitudinal direction or axis of the torque tube beam. As such, for mounting or securing a first set of bifacial photovoltaic modules and a second set of photovoltaic modules to a torque tube beam, the first and second sets of modules being in landscape orientation and positioned on opposite sides of the torque tube beam, what is desired is a mounting bracket assembly secured to the torque tube beam that: a) positions the first and second sets of bifacial photovoltaic modules in landscape orientation, when viewed in plan view, the first set being on one side of the torque tube beam and the second set being on the opposite side of the torque tube beam; and b) supports and secures longitudinally extending edge portions of the first and second sets of photovoltaic modules.

### SUMMARY

In one aspect, the present disclosure relates to a mounting bracket assembly affixed to a torque tube beam of a solar tracker assembly and supporting longitudinally extending edge portions of first and second photovoltaic modules wherein, when viewed in top plan view, the first photovoltaic module is on a first side of the torque tube beam and the second photovoltaic module is on an opposite side of the torque tube beam and the longitudinally extending edge portions of the first and second photovoltaic modules extend parallel to the torque tube beam, the mounting bracket assembly comprising: a) a first mounting bracket extending along a first mounting bracket axis extending transverse to the torque tube beam, the first mounting bracket including a central wall and a first and second side walls extending from the central wall, the first mounting bracket having a first end portion, a second end portion and a central portion extending between the first and second end portions; b) a first set of pedestals including a first central pedestal secured to the torque tube beam including a middle portion engaging the torque tube beam and first and second extending portions on opposite sides of the torque tube beam, the first central pedestal extending along the first mounting bracket axis and including a central wall and a lateral wall extending from the central wall, at least one of the first and second side walls of the first mounting bracket secured to the lateral wall of the first central pedestal; c) a first module support member including a first support arm and a second support arm, spaced from and extending parallel to the first support arm, the first support arm coupled to the first mounting bracket at the first end portion of the first mounting bracket, the second support arm coupled to the first extending portion of the first central pedestal; d) a second module support member including a third support arm and a fourth support arm, spaced from and extending parallel to the third support arm, the third support arm coupled to the first mounting bracket at the second end portion of the first mounting bracket, the fourth support arm coupled to the second extending portion of the first central pedestal; and f) wherein the first and second support arms are configured to support at least parts of the longitudinally extending edge portions of the first photovoltaic module and the third and fourth support arms are configured to support at least parts of the longitudinally extending edge portions of the second photovoltaic module.

In another aspect, the present disclosure relates to a mounting bracket assembly affixed to a torque tube beam of a solar tracker assembly and supporting longitudinally extending edge portions of first and second photovoltaic modules wherein, when viewed in top plan view, the first photovoltaic module is on a first side of the torque tube beam and the second photovoltaic module is on an opposite side of the torque tube beam and the longitudinally extending edge portions of the first and second photovoltaic modules extend parallel to the torque tube beam, the mounting bracket assembly comprising: a) a first mounting bracket extending along a first mounting bracket axis and a second mounting bracket, spaced from the first mounting bracket, extending along a second mounting bracket axis, the first and second mounting bracket axes extending transversely to the torque tube beam, the first mounting bracket including a central wall and a first side wall extending from the central wall, the first mounting bracket including a first end portion, a second end portion and a middle portion extending between the first and second end portions, the second mounting bracket including a central wall and a first side wall extending from the central wall, the second mounting bracket including a first end portion, a second end portion and a middle portion extending between the first and second end portions; b) a first set of pedestals including a first central pedestal secured to the torque tube beam including a middle portion engaging the torque tube beam and first and second extending portions on opposite sides of the torque tube beam, the first central pedestal extending along the first mounting bracket axis and including an upper wall and a lateral wall extending from the upper wall, the first side wall of the first mounting bracket secured to the first lateral wall of the first central pedestal; c) a second set of pedestals including a second central pedestal secured to the torque tube beam including a middle portion engaging the torque tube beam and first and end portions on opposite sides of the torque tube beam, the second central pedestal extending along the second mounting bracket axis and including an upper wall and a first lateral wall, the first side wall of the second mounting bracket secured to the first lateral wall of the second central pedestal; d) a first module support member including a first support arm and a second support arm, spaced from and extending parallel to the first support arm, the first support arm coupled to the first mounting bracket at the first end portion of the first mounting bracket and coupled to the second mounting bracket at the first end portion of the second mounting bracket, the second support arm coupled to the first extending portion of the first central pedestal and coupled to the first extending portion of the second central pedestal; e) a second module support member including a third support arm and a fourth support arm, spaced from and extending parallel to the third support arm, the third support arm coupled to the first mounting bracket at the second end portion of the first mounting bracket and coupled to the second mounting bracket at the second end portion of the second mounting bracket, the fourth support arm coupled to the second extending portion of the first central pedestal and coupled to the second extending portion of the second central pedestal; and f) wherein the first and second support arms are configured to support at least parts of the longitudinally extending edge portions of the first photovoltaic module and the third and fourth support arms are configured to support at least parts of the longitudinally extending edge portions of the second photovoltaic module.

In another aspect, the present disclosure relates to a mounting bracket assembly affixed to a torque tube beam of a solar tracker assembly and supporting longitudinally extending edge portions of a first photovoltaic module and respective longitudinally extending edge portions of a second photovoltaic module wherein, when viewed in top plan view, the first photovoltaic module is on a first side of the torque tube beam and the second photovoltaic module is on an opposite side of the torque tube beam and the longitudinally extending edge portions of the first and second photovoltaic modules extending parallel to the torque tube beam, the mounting bracket assembly comprising: a) a first mounting bracket coupled to the torque tube beam and extending along a first mounting bracket axis and a second mounting bracket, spaced from the first mounting bracket, coupled to the torque tube beam and extending along a second mounting bracket axis, the first and second mounting bracket axes, when viewed in top plan view, extending orthogonally to the torque tube beam, the first mounting bracket including a central wall and a first side wall extending from the central wall, the first mounting bracket including a first end portion, the first mounting bracket including a second end portion and a midpoint region between the first and second end portions, the second mounting bracket including a central wall and a first side wall extending from the central wall, the first mounting bracket having a first end portion, a second end portion and a midpoint region between the first and second end portions; b) a first module support member including a first support arm and a second support arm, spaced from and extending parallel to the first support arm, the first support arm coupled to the central wall of the first mounting bracket at the first end portion of the first mounting bracket and coupled to the central wall of the second mounting bracket at the first end of the second mounting bracket, the second support arm coupled to the central wall of the first mounting bracket between the first end portion and the midpoint region of the first mounting bracket and coupled to the central wall of the second mounting bracket between the first end portion and the midpoint region of the second mounting bracket; c) a second module support member including a third support arm and a fourth support arm, spaced from and extending parallel to the third support arm, the third support arm coupled to the central wall of the first mounting bracket at the second end portion of the first mounting bracket and coupled to the central wall of the second mounting bracket at the second end portion of the second mounting bracket, the fourth support arm coupled to the central wall of the first mounting bracket between the second end portion and the midpoint region of the first mounting bracket and coupled to the central wall of the second mounting bracket between the second end portion and the midpoint region of the second mounting bracket; and d) wherein the first and second support arms are configured to support at least parts of the longitudinally extending edge portions of the first photovoltaic module and the third and fourth support arms are configured to support at least parts of the longitudinally extending edge portions of the second photovoltaic module.

In another aspect, the present disclosure relates to combination of a mounting bracket assembly and a torque tube beam of a solar tracker assembly, the mounting bracket assembly secured to the torque tube beam and supporting longitudinally extending edge portions of first and second photovoltaic modules wherein, when viewed in top plan view, the first set of photovoltaic modules are on a first side of the torque tube beam and the second set of photovoltaic modules are on an opposite side of the torque tube beam and the longitudinally extending edge portions of the first and second photovoltaic modules extend parallel to the torque tube beam, the combination comprising: a) the torque tube beam extending along a longitudinal axis and including an upper wall and a lower wall spaced apart by first and second vertically extending side walls; and b) the mounting bracket assembly secured to the torque tube beam and including: i) a first mounting bracket extending along a first mounting bracket axis extending transverse to the torque tube beam, the first mounting bracket including a central wall and a first and second side walls extending from the central wall, the first mounting bracket having a first end portion, a second end portion and a central portion extending between the first and second end portions; ii) a first set of pedestals including a first central pedestal secured to the torque tube beam including a middle portion engaging the torque tube beam and first and second extending portions on opposite sides of the torque tube beam, the first central pedestal extending along the first mounting bracket axis and including a central wall and a lateral wall extending from the central wall, at least one of the first and second side walls of the first mounting bracket secured to the lateral wall of the first central pedestal; iii) a first module support member including a first support arm and a second support arm, spaced from and extending parallel to the first support arm, the first support arm coupled to the first mounting bracket at the first end portion of the first mounting bracket, the second support arm coupled to the first extending portion of the first central pedestal; iv) a second module support member including a third support arm and a fourth support arm, spaced from and extending parallel to the third support arm, the third support arm coupled to the first mounting bracket at the second end portion of the first mounting bracket, the fourth support arm coupled to the second extending portion of the first central pedestal; and v) wherein the first and second support arms are configured to support the longitudinally extending edge portions of the first photovoltaic module and the third and fourth support arms are configured to support the longitudinally extending edge portions of the second photovoltaic module.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic top perspective view of a first exemplary embodiment of a solar tracker assembly or system of the present disclosure including a torque tube beam, a plurality of bifacial photovoltaic modules, and a plurality of mounting bracket assemblies of the present disclosure for securing the plurality of bifacial photovoltaic modules to the torque tube beam, the plurality of bifacial photovoltaic modules being in landscape orientation;

FIG. 2 is a schematic top plan view of the solar tracker assembly of FIG. 1;

FIG. 3 is a schematic front elevation view of a portion of the solar tracker assembly of FIG. 1 depicting a first exemplary embodiment of a representative mounting bracket assembly of the present disclosure and the torque tube beam to which the representative mounting bracket assembly is affixed;

FIG. 3A is a schematic enlarged front elevation view of a portion of the solar tracker assembly shown in FIG. 3 that is within a dashed line labeled FIG. 3A in FIG. 3;

FIG. 4 is a schematic bottom perspective view of a portion of the solar tracker assembly of FIG. 1 showing features of the mounting bracket assembly of FIG. 3;

FIG. 5 is a schematic bottom perspective view of a portion of the solar tracker assembly of FIG. 1 showing features of the mounting bracket assembly of FIG. 3;

FIG. 6 is a schematic side elevation view of a portion of the solar tracker assembly of FIG. 1 showing features of the mounting bracket assembly of FIG. 3;

FIG. 7 is a schematic top plan view of the mounting bracket assembly of FIG. 3 in an assembled or module supporting configuration;

FIG. 8 is a schematic top plan view of the module bracket assembly of FIG. 3 in a folded or transportation configuration; and

FIG. 9 is a schematic front elevation view of a portion of a solar tracker assembly depicting a second exemplary embodiment of a mounting bracket assembly of the present disclosure, the mounting bracket assembly being configured for mounting to a lower wall or lower portion of a torque tube beam of the solar tracker assembly, referred to herein as a “below the torque tube beam” mounting configuration, for securing a plurality of bifacial photovoltaic modules in landscape orientation to the torque tube beam;

FIG. 10 is a schematic top perspective view of a portion of a solar tracker assembly depicting a third exemplary embodiment of a mounting bracket assembly of the present disclosure, the mounting bracket assembly being configured for mounting to a lower wall or lower portion of a torque tube beam of the solar tracker assembly to secure a plurality of bifacial photovoltaic modules in landscape orientation to the torque tube beam in a “below the torque tube beam” mounting configuration;

FIG. 11 is a schematic bottom perspective view of the mounting bracket assembly of FIG. 10, as seen from a plane indicated by the line 11-11 in FIG. 10;

FIG. 12 is a schematic top plan view of the mounting bracket assembly of FIG. 10, as seen from a plane indicated by the line 12-12 in FIG. 10;

FIG. 13 is a schematic top perspective view of a truncated version of the mounting bracket assembly of FIG. 10, the mounting bracket assembly truncated at a first mounting bracket to illustrate a configuration of an attachment structure including a first set of pedestals interposed between the first mounting bracket and a set of support arms of a photovoltaic module support framework;

FIG. 14 is a schematic enlarged, exploded top perspective view of a central portion of the truncated version of FIG. 13 of the mounting bracket assembly of FIG. 10;

FIG. 15 is a schematic front elevation view of the truncated version of FIG. 13 of the mounting bracket assembly of FIG. 10;

FIG. 16 is a schematic view, partly in front elevation and partly in vertical section, of the truncated version of FIG. 13 of the mounting bracket assembly of FIG. 10;

FIG. 17 is a schematic vertical section view of the view of the truncated version of FIG. 13 of the mounting bracket assembly of FIG. 10, as seen from a plane indicated by the line 17-17 in FIG. 16; and

FIG. 18 is a schematic front elevation view of two adjacent mounting bracket assemblies of a fourth exemplary embodiment of the present disclosure, the mounting bracket assemblies being configured for mounting to a lower wall or lower portion of a torque tube beam of the solar tracker assembly to secure a plurality of bifacial photovoltaic modules in landscape orientation to the torque tube beam in a “below the torque tube beam” mounting configuration.

### DETAILED DESCRIPTION

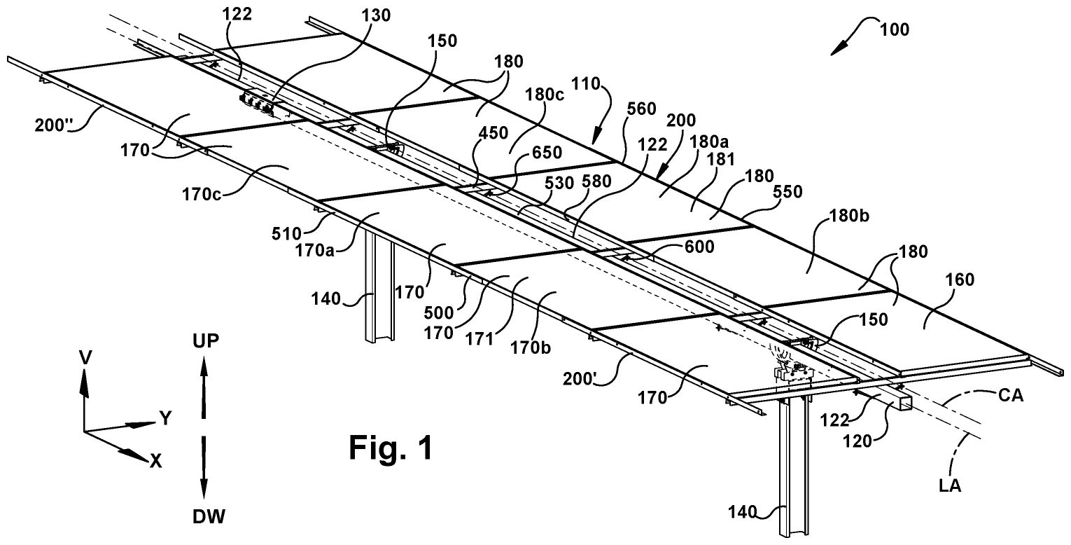

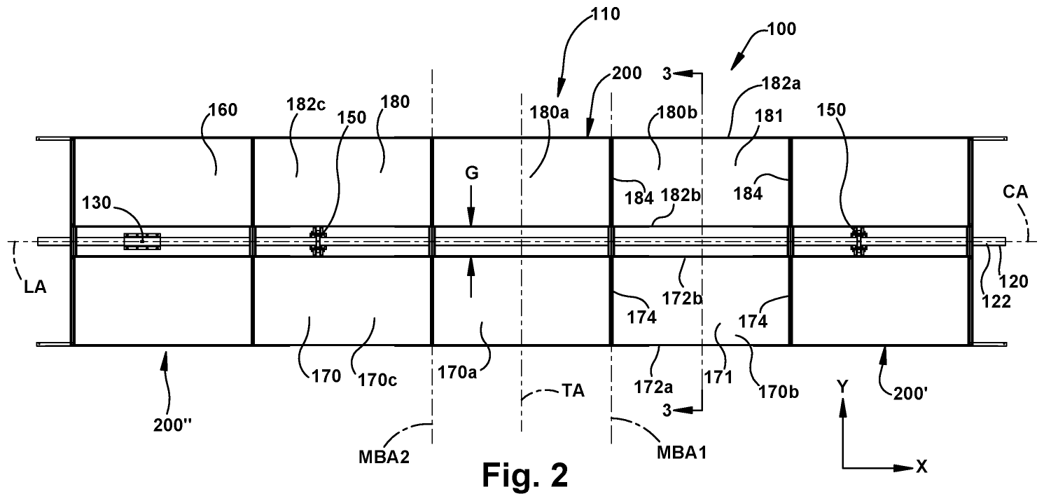

The present disclosure relates to a mounting bracket assembly 200 for supporting a plurality of bifacial photovoltaic panels or modules 160 of a single axis solar tracker assembly 100 (also interchangeably referred to herein as a solar tracker system, a solar tracker apparatus, a solar tracking assembly, a solar tracking system, or a solar tracking apparatus) and coupling the plurality of bifacial photovoltaic modules 160 to a torque tube beam 120 of the solar tracker system or assembly or apparatus 100. Specifically, the mounting bracket assembly 200 of the present disclosure, a first exemplary embodiment of which is depicted schematically in FIGS. 1-8, is configured to support the plurality of bifacial photovoltaic modules 160 in two spaced apart sets of photovoltaic modules 170, 180 in landscape orientation, that is, such that the longer edges of the first and second sets of modules 170, 180 extend parallel to the torque tube beam 120. When viewed in top plan view, as best seen in FIG. 2, the first and second sets of photovoltaic modules 170, 180 are on opposite sides of the torque tube beam 120 and the facing longer edges of the modules are spaced apart by a gap or distance G. The gap G advantageously allows for sunlight to pass through the gap G and be reflected back from the ground/substrate and/or the torque tube beam 120 toward the lower or back surfaces surface (facing away from the sun) of the first and second sets of photovoltaic modules 170, 180 thereby increasing the quantity of indirect sunlight energy absorbed by those surfaces. The gap G also advantageously provides a central clearance area for dumping of snow from the upper or front surfaces of the first and second sets of photovoltaic modules if snow is sensed on the modules by a control systems of the tracker system 100 and a snow dumping routine is initiated by the control system to pivot the torque tube beam 120 (and thereby also pivot the plurality of modules 160 affixed thereto by the mounting bracket assembly 200) to remove the built up snow from the plurality of modules 160.

In the exemplary embodiment disclosed in FIGS. 1-5, the solar tracker system 100 is a horizontal, single axis solar tracker system, however, it should be appreciated that the mounting bracket assembly 1200 of the present disclosure can be advantageously utilized in a variety of solar tracker systems having a plurality of photovoltaic modules 160 needing to be affixed or secured to a torque tube beam 120 wherein it is desired to have the modules 160 in landscape orientation, in two sets of modules separated by a gap G between facing edges of the two sets of modules, as schematically depicted in FIG. 2. The solar tracker assembly 100 will include a plurality of mounting bracket assemblies 200 of the present disclosure, extending along a length of the torque tube beam 120. For simplicity, only a portion of the solar tracker assembly is depicted in the drawing figures. For example, one mounting bracket assembly is shown in its entirety and parts of two other mounting bracket assemblies of the present disclosure are shown in FIG. 1. The mounting bracket assemblies 200 are part of a table 110 of the solar tracker system 100 and used to mount the plurality of photovoltaic modules 160 to the torque tube beam 120 of the table 110. The table 110 includes all components of the solar tracker system 100 that are driven by an actuator mechanism, such as a slew drive or linear actuator (not shown) to pivot about an axis of rotation of the table 110 of the solar tracker system 100. The table 110 includes the plurality of photovoltaic modules 160, the torque tube beam 120, and a plurality of rotatable bearing assemblies 150 that support the torque tube beam 120. Each of the bearing assemblies 150 is mounted to a support post 140, which is driven into the ground or substrate.

The torque tube beam 120 comprises a plurality of torque tube beam segments 122. Facing ends of adjacent torque tube beam segments 122 are coupled or affixed by a coupler 130. The rotatable bearing assemblies 150 support the torque tube beam 120 and constrain the torque tube beam 120 to pivot or swing about the axis of rotation. In one exemplary embodiment, the torque tube beam 120 is a metal tube that is substantially square in cross section, having a hollow interior, and is centered about the torque tube beam longitudinal axis LA. In one exemplary embodiment the torque tube beam 120 is approximately 100 mm. by 100 mm. (approximately 4 in. by 4 in.) and includes a horizontal top or upper wall 124 and a horizontal lower wall 126, spaced apart by a pair of vertically extending side walls 128. Additional details regarding the solar tracker system 100 and the various components thereof are disclosed in U.S. Pat. No. 10,944,354 to Ballentine et al., issued Mar. 9, 2021, and entitled Solar Tracker Bearing Apparatus and in U.S. Pat. No. 11,271,518 to Ballentine et al., issued Mar. 8, 2022, and entitled Mounting Bracket for Mounting Photovoltaic Modules to Torque Tube Beam. U.S. Pat. Nos. 10,944,354 and 11,271,518 are both assigned to the assignee of the present application, and both are hereby incorporated by reference in their respective entireties herein.

### First Exemplary Embodiment—Mounting Bracket Assembly 200

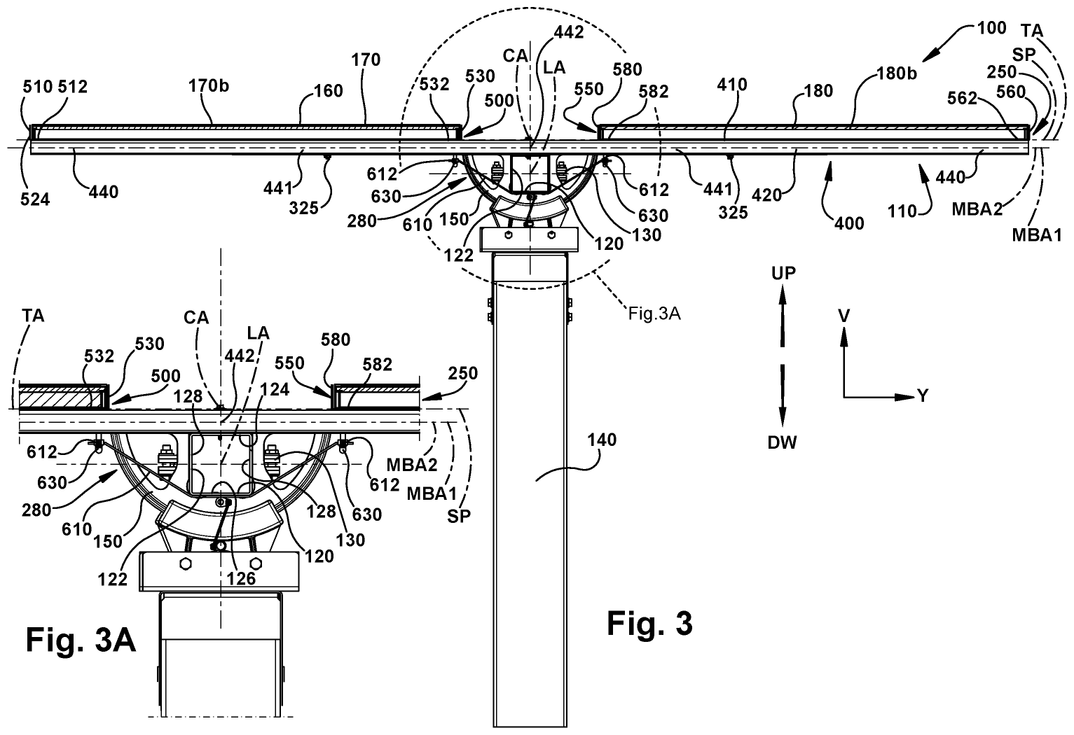

Individual mounting bracket assemblies 200 of the solar tracker assembly 100 are positioned in uniformly spaced apart locations along an extent of the torque tube beam 120, that is, spaced along a longitudinal axis LA of the torque tube beam 120, as schematically depicted in FIGS. 1 and 2. Each of the mounting bracket assemblies of the plurality of mounting bracket assemblies are substantially identical and thus it will be understood that the description of the representative mounting bracket assembly 200 of the present disclosure applies equally to all of the mounting bracket assemblies of the solar tracker system 100. As mounted on the mounting bracket assemblies 200, the first and second sets of photovoltaic modules 160, 170, when viewed in top plan view, are spaced by the gap G and are centered about and on opposite sides of the torque tube beam 120. Additionally, as best seen in FIG. 3, the mounting bracket assemblies 200 position the first and second sets of photovoltaic modules 160, 170 such that they are spaced vertically above (in the upward direction UP) above the torque tube beam 120. As used herein, the direction X is a horizontal direction parallel to the torque tube beam longitudinal axis LA, typically, in the north-south direction, the direction Y is a horizontal direction orthogonal to the torque tube beam longitudinal axis LA, typically in the east-west direction, and the direction V is a vertical direction orthogonal to X and Y directions. The vertical direction V includes the upward direction UP, away from the ground/substrate, and the downward direction DW, toward the ground/substrate. The mounting bracket assemblies 200 both support first and second spaced apart sets of photovoltaic modules 160, 170 and secure or couple the sets of photovoltaic modules 160, 170 to the torque tube beam 120 such that the sets of photovoltaic modules 160, 170 pivot or rotate with the torque tube beam 120 and the upper surfaces of the sets of photovoltaic modules 160, 170 track the sun as the sun travels from east to west across the sky. As used herein, when referring to a horizontal position or orientation of components of the solar tracker assembly 100, it is assumed that the solar tracker assembly is in a neutral position, as opposed to a tilted position, that is, with the sets of photovoltaic modules 160, 170 will be facing in the upward direction UP, as depicted, for example, in FIGS. 2 and 3.

With reference to the representative mounting bracket assembly 200, the mounting bracket assembly supports three bifacial photovoltaic modules 170a, 170b, 170c of the first set of photovoltaic modules 170 and three bifacial photovoltaic modules 180a, 180b, 180c of the second set of photovoltaic modules 180. Specifically, the mounting bracket assembly 200 entirely supports the center modules 170a, 180a and partially supports the two flanking modules 170b, 180b on one side and partially supports the two flanking modules 170c, 180c on the opposite side. The modules 170b, 180b are supported by the combination of the mounting bracket assembly 200 and the adjacent mounting bracket assembly 200′ (as seen in FIGS. 1 and 2) and the modules 170c, 180c are supported by the combination of the mounting bracket 200 and the adjacent mounting bracket 200″ (FIGS. 1 and 2). To avoid potential damage or breakage, when bifacial photovoltaic modules such as the first and second sets of photovoltaic modules 160, 170, are supported by the mounting bracket 200 of the solar tracker system 100, advantageously, each of the photovoltaic modules is supported and secured to the mounting bracket 200 along their longer longitudinal edges, as opposed to supporting the modules along the shorter transverse edges. As mentioned previously, it is also desired that the bifacial photovoltaic modules, like the first second sets of photovoltaic modules 160, 170, be positioned in the landscape orientation (that is, the longer longitudinal edges of the modules extending parallel to the torque tube beam longitudinal axis LA). Advantageously, in the mounting bracket assembly 200 of the present disclosure, each of the plurality of photovoltaic modules 170a, 170b, 170c, 180a, 180b, 180c are supported along their respective longer longitudinal edge portions, as opposed to being supported by their shorter transverse edge portions. That is, in viewing a representative module 171 of the first set of photovoltaic modules 170, the module 171 is supported along its longitudinal edges or longitudinal edge portions 172a, 172b by the combination of mounting bracket assembly 200 and the adjacent mounting bracket 200′, as opposed to the shorter transverse edge portions 174 of the module 171 which extend orthogonally to the longitudinal edge portions 172a, 172b. Similarly, in viewing a representative module 181 of the second set of photovoltaic modules 180, the module 181 is supported along its longitudinal edges or longitudinal edge portions 182a, 182b by the combination of mounting bracket assembly 200 and the adjacent mounting bracket 200′, as opposed to the shorter transverse edge portions 184 of the module 181 which extend orthogonally to the longitudinal edge portions 182a, 182b.

As best seen in FIGS. 2, 4, 6 and 7, in one exemplary embodiment, the mounting bracket assembly 200 includes: a) a module support framework 250 including a first module support member 500 for supporting a subset of the first set of photovoltaic modules 170, specifically, longitudinally extending edges of modules 170a, 170b, 170c, and a second module support member 550 for supporting a subset of the second set of photovoltaic modules 180, specifically, longitudinally extending edges of modules 180a, 180b, 180c; and b) an attachment structure 280 including first and second base members 200, 250, first and second mounting brackets 400, 450 and first and second securement members 600, 650 for securing or coupling the module support framework 250, and thereby securing or coupling the first and second set of photovoltaic modules 170, 180, to the torque tube beam 120. With respect to explaining the components of the representative mounting bracket assembly 200, reference to the first and second sets of photovoltaic modules 170, 180, will be understood to mean the subset of modules 170a, 170b, 170c of the first set of modules 170 and will be understood to mean the subset of modules 180a, 180b, 180c of the second set of modules 180. The mounting bracket assembly 200 includes a central axis CA (FIGS. 2 and 3) which is parallel to and vertically spaced above the torque tube beam longitudinal axis LA. A transverse axis TA of the mounting bracket assembly 200 intersects and is orthogonal to the central axis CA. Both the central and transverse axes CA, TA are coincident with a horizontal support plane SP defined by the mounting bracket assembly 200. The support plane SP is defined by respective horizontal bases 512, 532 of first and second support arms 510, 530 of the first module support member 500 of the module support framework 250 of the mounting bracket assembly 200 and respective horizontal bases 562, 582 of the third and fourth support arms 560, 580 of the second module support member 550 of the module support framework 250 of the mounting bracket assembly 200 which function to support the longer or longitudinally extending edges of modules 170a, 170b, 170c of the first set of modules 170 and the longitudinally extending edges of modules 180a, 180b, 180c of the second set of modules 180. Stated another way, the module support framework 250, at least in part, includes bases 512, 532, 562, 582 that define a plurality of support surfaces for supporting the longitudinally extending edges of modules 170a, 170b, 170c of the first set of modules 170 and the longitudinally extending edges of modules 180a, 180b, 180c of the second set of modules 180. The support surfaces defined by the bases 512, 532, 562, 582, in turn, define the horizontal support plane SP. The support plane SP includes both the mounting bracket assembly central axis CA and the transverse axis TA.

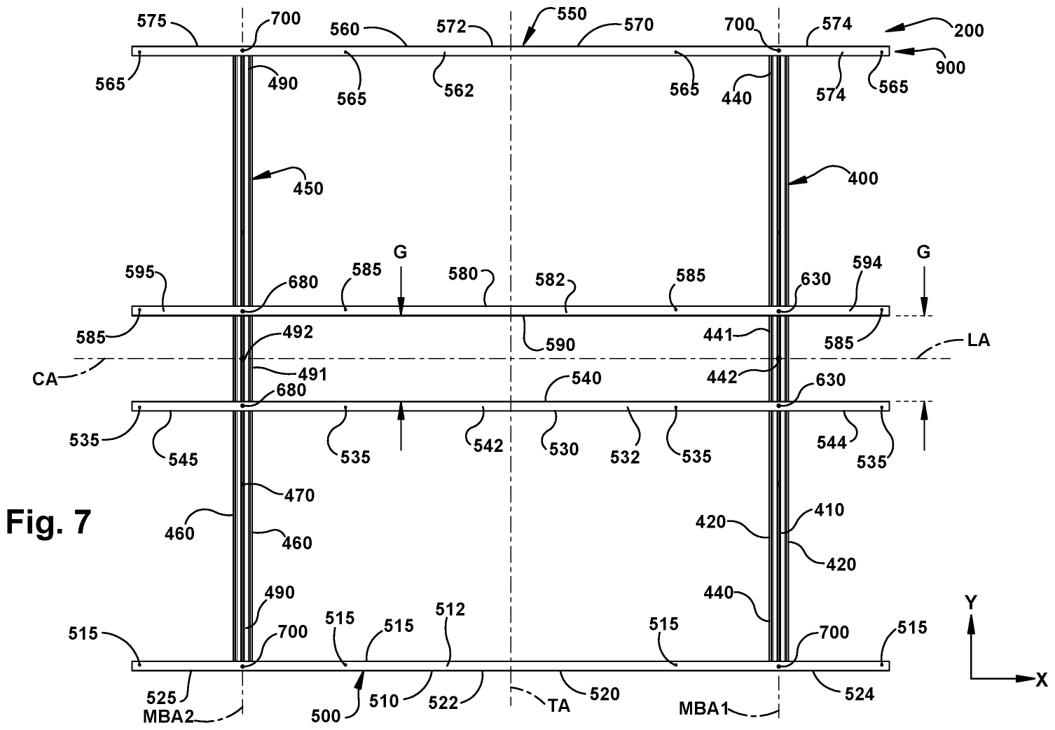

With respect to the attachment structure 280 of the mounting bracket assembly 200, the first and second base members 200, 250 and first and second mounting brackets 400, 450 extend along respective first and second mounting bracket axes MBA1, MBA2 (FIG. 7) that are horizontal and orthogonal to the mounting bracket assembly central axis CA and parallel to the transverse axis TA. With respect to vertical position, the first and second mounting bracket axes MBA1, MBA2 are disposed between the central and transverse axes CA, TA of the mounting bracket assembly 200 and the torque tube beam longitudinal axis LA, that is, vertically upward UP with respect to the torque tube beam longitudinal axis LA and vertically downward DW with respect to the central and transverse axes CA, TA.

Attachment Structure 280

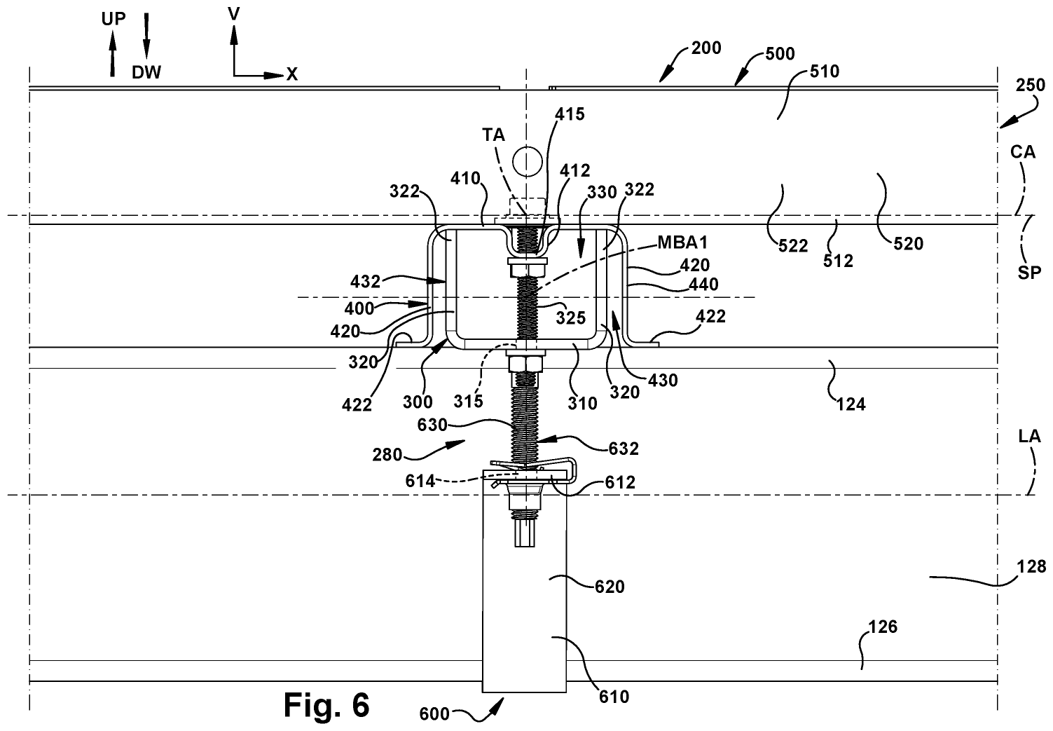

In one exemplary embodiment and as best seen in FIGS. 3, 4 and 6, the mounting bracket assembly 200 includes the attachment structure 280 comprising the first and second base members 200, 250, the first and second mounting brackets 400, 450, which respectively receive the first and second base members 300, 350 in nested relationship 432, and first and second securement members 600, 650 for securing or coupling the module support framework 250 (and the first and second sets of photovoltaic modules 170, 180 mounted thereto) to the torque tube beam 120. As best seen in FIG. 6, the first base member 300 of the attachment structure 280 extends along the first mounting bracket axis MBA1 and includes a generally planar central or lower wall 310 and first and second side walls 320 extending upwardly from the central or lower wall 310. The first and second side walls 320 are substantially parallel with each other and are substantially parallel to the first mounting bracket axis MBA1. The central wall 310 includes a plurality of openings and the central wall 310 and the first and second side walls 320 define a generally u-shaped opening 330. Similarly, the second base member 350 of the attachment structure 280 is identical of the first base member 300 and extends along the second mounting bracket axis MBA2 and includes a generally planar central or lower wall 360 and first and second side walls 370 extending upwardly from the central or lower wall 360. The first and second side walls 320 are substantially parallel with each other and are substantially parallel to the second mounting bracket axis MBA2. The central wall 360 includes a plurality of openings and the central wall 360 and the first and second side walls 370 define a longitudinally extending generally u-shaped opening 330.

The first mounting bracket 400 of the attachment structure 280 extends along the first mounting bracket axis MBA1 and includes a central or upper wall 410 and first and second side walls 420 extending downwardly from the central or upper wall 410, the first and second side walls 420 each includes horizontal end portions 422 that bear against the upper wall 124 of the torque tube beam 120. The first and second side walls 420 are substantially parallel with each other and are substantially parallel to the first mounting bracket axis MBA1. The upper wall 410 includes a recessed central region 412 which includes a plurality of openings 415. The central wall 410 and the first and second side walls 420 define an inverted u-shaped opening 430. The inverted u-shaped opening 430 of the first mounting bracket 400 receives the first base member 300 in a nested relationship 432, as best seen in FIG. 6. Looking along a length of the first mounting bracket 400, the first mounting bracket 400 includes first and second end portions 440 spaced apart by a central portion 441. The central portion 441 includes a midpoint region 442 which bisects a longitudinal extent, as measured along the first mounting bracket axis MBA1 of the first mounting bracket 400.

The second mounting bracket 450 of the attachment structure 280 is substantially identical to the first mounting bracket 400 and extends along the second mounting bracket axis MBA2 and includes an upper wall 460 and first and second side walls 470 extending downwardly from the upper wall 460, the first and second side walls 470 each includes horizontal end portions that bear against the upper wall 124 of the torque tube beam 120. The first and second side walls 470 are substantially parallel with each other and are substantially parallel to the second mounting bracket axis MBA1. The upper wall 460 includes a recessed central region which includes a plurality of openings. The upper wall 460 and the first and second side walls 470 define an inverted u-shaped opening. The inverted u-shaped opening of the second mounting bracket 450 receives the second base member 350 in the nested relationship. Looking along a length of the second mounting bracket 450, the second mounting bracket 450 includes first and second end portions 490 spaced apart by a central portion 491. The central portion 491 includes a midpoint region 492 which bisects a longitudinal extent, as measured along the second mounting bracket axis MBA2, of the second mounting bracket 450.

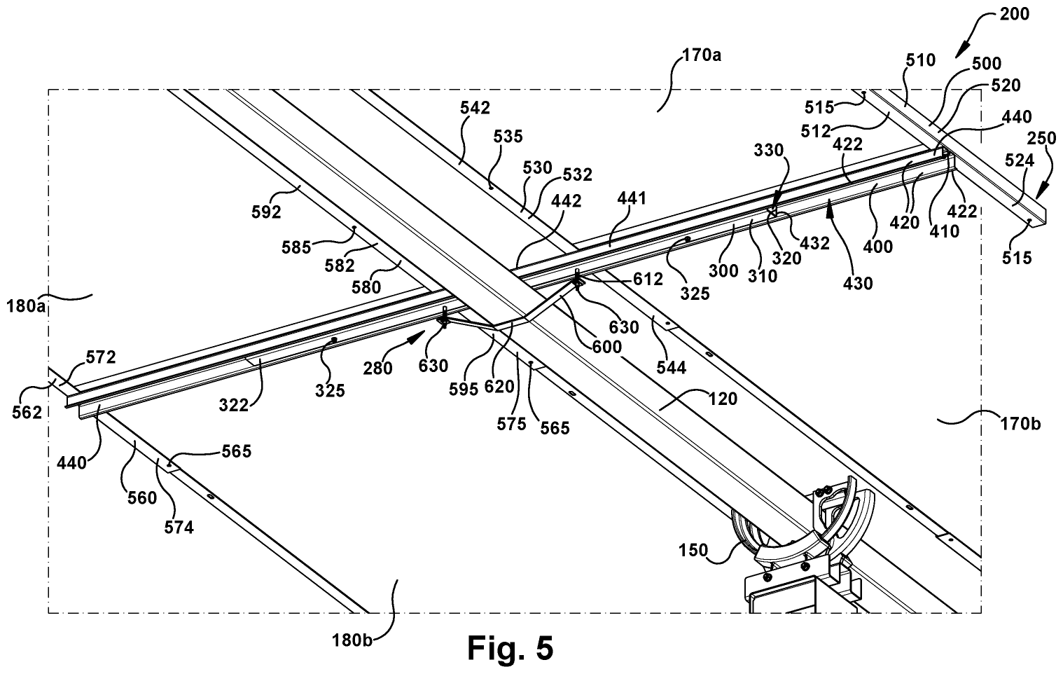

As mentioned above, the first base member 300 is disposed in a nested configuration or relationship 432 within the inverted u-shaped opening 430 defined by the upper wall 410 and side walls 420 of the first mounting bracket 400 and the second base member 350, which is substantially identical to the first base member 300, is similarly disposed in a nested configuration or relationship within the inverted u-shaped opening defined by the upper wall 460 and side walls 470 of the second mounting bracket 450. As best seen in FIG. 6, the upper end portions 322 of the first and second side walls 320 of the first base member 300 bear against and provide support to the upper wall 410 of the first mounting bracket 400 thereby advantageously providing reinforcement and additional structural rigidity to the first mounting bracket 400 and enhancing the overall strength and structural rigidity of the mounting bracket assembly 200 as a whole. Similarly, the upper end portions of the first and second side walls 370 of the second base member 350 bear against and provide support to the upper wall 460 of the second mounting bracket 450 thereby advantageously providing reinforcement and additional structural rigidity to the second mounting bracket 400 and enhancing the overall strength and structural rigidity of the mounting bracket assembly 200 as a whole. As can best be seen in FIG. 5, in one exemplary embodiment, the first base member 300 is centered along a length of the first mounting bracket 400 and, as measured along the mounting bracket axis MBA1, a length of the first base member 300 is about 60% of the length of the first mounting bracket 400 as measured along the mounting bracket axis MBA1. Similarly, in one exemplary embodiment, the second base member 350 is centered along a length of the second mounting bracket 450 and, as measured along the mounting bracket axis MBA2, is about 60% of the length of the second mounting bracket 450, as measured along the mounting bracket axis MBA2.

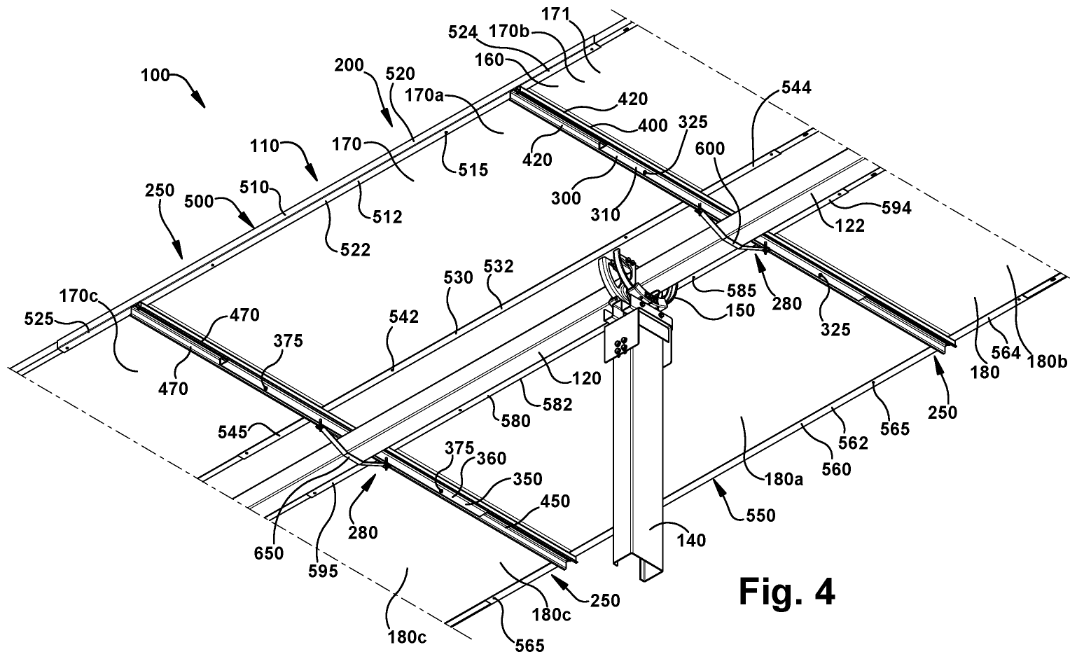

As best seem in FIGS. 4-6, the first securement member 600 of the attachment structure 280 includes a strap 610. The strap 610 includes end portions 612 with openings 614. The openings 614 at opposite end portions 612 of the strap 610 receive a first pair of connectors 630. Each connector of the first pair of connectors 630 includes a threaded fastener body 632 and associated mating nuts. The threaded fastener body 632 passes through aligned openings of: a) the end portions 612 of the strap 610; b) the lower wall 310 of the first base member 300; and c) the recessed central region 412 of the upper wall 410 of the first mounting bracket 400. When the strap 610 of the first securement member 600 is tightened against the lower wall 126 of the torque tube beam 120 by the first pair of connectors 630: a) the strap 610 bears against the lower wall 126 of the torque tube beam 120; b) the lower wall 310 of the first base member 310 bears against the upper wall 124 of the torque tube beam 120; c) the horizontal end portions 422 of the side walls 420 of the first mounting bracket 400 bear against the upper wall 124 of the torque tube beam 120; and d) the upper ends of the side walls 322 of the first base member 310 bears against the upper wall 410 of the first mounting bracket 400. Additionally, when the strap 610 of the first securement member 600 is tightened against the lower wall 126 of the torque tube beam 120 by the first pair of threaded connectors 630, both the horizontal base 532 of the second support arm 530 of the first module support member 500 and the horizontal base 582 of the fourth support arm 580 of the second module support member 550 are secured to and bear against the upper wall 410 of the first mounting bracket 400 to thereby secure the first and second module support members 500, 550 to the first mounting bracket 400 and thereby securely couple the first and second module support members 500, 550 (along with the first and second sets of photovoltaic modules 170, 180 supported by the support members 500, 550) to the torque tube beam 120. Further, as best seen in FIGS. 3-6, in addition to the first pair of threaded connectors 630 which function to secure the first base member 300 and the first mounting bracket 400, the first base member 300 and the first mounting bracket 400 are additionally affixed by a plurality of threaded fasteners 325, which are part of the attachment structure 280. The plurality threaded fasteners 325 pass through aligned openings in the central wall 310 of the first base member 300 and the central wall 410 of the first mounting bracket 400 to secure the first base member 300 to the first mounting bracket 400.

Similarly, the second securement member 650 of the attachment structure 280 is substantially identical to the first securement member 600 and includes a strap 660. The strap 660 includes end portions 662 with openings. The openings at opposite end portions 662 of the strap 660 receive a second pair of threaded connectors 680. Each connector of the second pair of connectors 680 includes a threaded fastener body 632 and associated mating nuts which thread onto the threaded fastener body. The threaded fastener body 632 passes through aligned openings of: a) the end portions 662 of the strap 660; b) the lower wall 360 of the second base member 350; and c) the recessed central region of the upper wall 460 of the second mounting bracket 450. When the strap 660 of the second securement member 650 is tightened against the lower wall 126 of the torque tube beam 120 by the second pair of connectors 680: a) the strap 660 bears against the lower wall 126 of the torque tube beam 120; b) the lower wall 310 of the second base member 360 bears against the upper wall 124 of the torque tube beam 120; c) the horizontal end portions of the side walls 470 of the second mounting bracket 450 bear against the upper wall 124 of the torque tube beam 120; and d) the upper ends of the side walls 322 of the first base member 310 bears against the central or upper wall 410 of the first mounting bracket 400. Additionally, when the strap 660 of the second securement member 650 is tightened against the lower wall 126 of the torque tube beam 120 by the second pair of connectors 680, both the horizontal base 532 of the second support arm 530 of the first module support member 500 and the horizontal base 582 of the fourth support arm 580 of the second module support member 550 are secured to and bear against the upper wall 460 of the second mounting bracket 450 to thereby secure the first and second module support members 500, 550 to the second mounting bracket 450 and thereby securely couple the first and second module support members 500, 550 (along with the first and second sets of photovoltaic modules 170, 180 supported by the support members 500, 550) to the torque tube beam 120. Further, as best seen in FIGS. 3-6, in addition to the second pair of threaded connectors 680, which function to secure the first base member 300 and the first mounting bracket 400, the second base member 350 and the second mounting bracket 450 are additionally affixed by a plurality of threaded fasteners 375, which are part of the attachment structure 280. The plurality threaded fasteners 375 pass through aligned openings in the central wall 360 of the second base member 350 and the central wall 460 of the second mounting bracket 450 to secure the second base member 350 to the second mounting bracket 400.

Module Support Framework 250

The module support framework 250 supports the first and second sets of photovoltaic modules 170, 180 and includes the first and second module support members 500, 550. The module support members are affixed, via the attachment structure 280, to the torque tube beam 120 such that the first and second sets of photovoltaic modules 170, 180 pivot with the torque tube beam 130. As viewed in top plan view (FIGS. 2 and 7), the first and second module support members 550, 550 are on opposite sides of and spaced from the torque tube beam 120 thereby defining the gap G between facing, longitudinally extending edges of the first and second sets of photovoltaic modules 170, 180. The gap G is substantially equal to the distance between a vertically extending ledge 540 of the second support arm 530 of the first module support member 500 and a vertically extending ledge 590 of the fourth support arm 580 of the second module support member 550.

In one exemplary embodiment, the first module support member 500 includes two parallel support arms, namely, first and second support arms 510, 530, which extend parallel to each other and the central axis CA of the mounting bracket assembly 200. The second support arm 530 is closer to the central axis CA and the distance between the first and second support arms 510, 530 is sized to accept the shorter transverse sides of the first set of photovoltaic modules 170. The first support arm 510 includes the horizontal base 512 extending orthogonally from a vertically extending ledge 520. The horizontal base 512 and the vertically extending ledge 520 advantageously provide support to and constrain movement of the first set of photovoltaic modules 170 with respect to the mounting bracket assembly 200. The horizontal base 512 of the first support arm 510 includes openings 515 which are configured to receive connectors which secure the modules 170a, 170b, 170c to the support arm 510. Looking along a length or extent of the first support arm 510, the first support arm 510 includes a central portion 522 which supports an entirety of an outwardly facing longitudinal edge of the photovoltaic module 170a of the first set of photovoltaic modules 170. The central portion 522 of the first support arm 510 extends between the end portion 440 of the first mounting bracket 400 and the end portion 490 of the second mounting bracket 450. The first support arm 510 also includes first and second extending end portions 524, 525. The first end portion 524 of the first support arm 510 extends beyond the end portion 440 of the first mounting bracket 400 and supports a portion of an outwardly facing longitudinal edge of the photovoltaic module 170b of the first set of photovoltaic modules 170, while the second end portion 525 of the first support arm 510 extends beyond the end portion 490 of the second mounting bracket 450 and supports a portion of an outwardly facing longitudinal edge portion of the photovoltaic module 170c of the first set of photovoltaic modules 170. By “inwardly facing longitudinal edge”, what is being referred to is the photovoltaic module longitudinally extending edge closer to and facing toward the mounting bracket assembly central axis CA, i.e., the longitudinal edge portion labeled 172b of the representative photovoltaic module 171 in FIG. 2. By “outwardly facing longitudinal edge”, what is being referred to is the photovoltaic module longitudinally extending edge further away from and facing away from the mounting bracket assembly central axis CA, i.e., the longitudinal edge portion labeled 172a of the representative photovoltaic module 171 in FIG. 2.

The second support arm 530 of the first module support member 500 includes the horizontal base 532 extending orthogonally from a vertically extending ledge 540. The horizontal base 532 and the vertically extending ledge 540 advantageously provide support to and constrain movement of the first set of photovoltaic modules 170 with respect to the mounting bracket assembly 200. The horizontal base 532 of the second support arm 530 includes openings 535 which are configured to receive connectors which secure the modules 170a, 170b, 170c to the support arm 530. Looking along a length or extent of the second support arm 530, the second support arm 530 includes a central portion 542 which supports an entirety of an inwardly facing longitudinal edge of the photovoltaic module 170a of the first set of photovoltaic modules 170. The central portion 542 of the second support arm 530 extends between the end portion 440 of the first mounting bracket 400 and the end portion 490 of the second mounting bracket 450. The second support arm 530 also includes first and second extending end portions 544, 545. The first end portion 544 of the second support arm 530 extends beyond the end portion 440 of the first mounting bracket 400 and supports a portion of an inwardly facing longitudinal edge of the photovoltaic module 170b of the first set of photovoltaic modules 170, while the second end portion 545 of the second support arm 530 extends beyond the end portion 490 of the second mounting bracket 450 and supports a portion of an inwardly facing longitudinal edge of the photovoltaic module 170c of the first set of photovoltaic modules 170.

The third support arm 560 of the second module support member 550 includes the horizontal base 562 extending orthogonally from a vertically extending ledge 570. The horizontal base 562 and the vertically extending ledge 570 advantageously provide support to and constrain movement of the second set of photovoltaic modules 180 with respect to the mounting bracket assembly 200. The horizontal base 562 of the third support arm 560 includes openings 565 which are configured to receive connectors which secure the modules 180a, 180b, 180c to the support arm 560. Looking along a length or extent of the third support arm 560, the third support arm 560 includes a central portion 572 which supports an entirety of an outwardly facing longitudinal edge of the photovoltaic module 180a of the second set of photovoltaic modules 180. The central portion 572 of the third support arm 560 extends between the end portion 440 of the first mounting bracket 400 and the end portion 490 of the second mounting bracket 450. The third support arm 560 also includes first and second extending end portions 574, 575. The first end portion 574 of the third support arm 560 extends beyond the end portion 440 of the first mounting bracket 400 and supports a portion of an outwardly facing longitudinal edge of the photovoltaic module 180b of the second set of photovoltaic modules 180, while the second end portion 575 of the third support arm 560 extends beyond the end portion 490 of the second mounting bracket 450 and supports a portion of an outwardly facing longitudinal edge of the photovoltaic module 180c of the second set of photovoltaic modules 170.

The fourth support arm 580 of the second module support member 550 includes the horizontal base 582 extending orthogonally from a vertically extending ledge 590. The horizontal base 582 and the vertically extending ledge 590 advantageously provide support to and constrain movement of the second set of photovoltaic modules 180 with respect to the mounting bracket assembly 200. The horizontal base 582 of the fourth support arm 580 includes openings 585 which are configured to receive connectors which secure the modules 180a, 180b, 180c to the support arm 580. Looking along a length or extent of the fourth support arm 580, the fourth support arm 580 includes a central portion 592 which supports an entirety of an inwardly facing longitudinal edge of the photovoltaic module 180a of the second set of photovoltaic modules 180. The central portion 592 of the fourth support arm 580 extends between the end portion 440 of the first mounting bracket 400 and the end portion 490 of the second mounting bracket 450. The fourth support arm 580 also includes first and second extending end portions 594, 595. The first end portion 594 of the fourth support arm 580 extends beyond the end portion 440 of the first mounting bracket 400 and supports a portion of an outwardly facing longitudinal edge of the photovoltaic module 180b of the second set of photovoltaic modules 180, while the second end portion 595 of the fourth support arm 580 extends beyond the end portion 490 of the second mounting bracket 450 and supports a portion of an outwardly facing longitudinal edge of the photovoltaic module 180c of the second set of photovoltaic modules 180.

It should be understood and appreciated that, for cost-saving purposes, especially under low-load conditions, it may be sufficient for the first and second sets of photovoltaic modules 170, 180 to only be secured to mounting bracket assembly by affixing (for example, by bolting or clamping) the transverse edge portions 174 of photovoltaic modules, such as the representative photovoltaic module 171, of the first set of photovoltaic modules 170 to the upper walls 410, 460 of the first and second mounting brackets 400, 450 and similarly by affixing, by bolting or clamping, the transverse edge portions of photovoltaic modules of the second set of photovoltaic modules 180 to the upper walls 410, 460 of the first and second mounting brackets 400, 450. That is, longitudinally extending edge portions 172a, 172b of the modules, such as the representative module 171, of the first set of photovoltaic modules 170 may rest on (without being affixed to by, for example, bolting or clamping) the first and second support arms 510, 530 of the first module support member 500. As such, the first and second support arms 510, 530 engage and support the respective longitudinally extending edge portions 172a, 172b of the photovoltaic modules, such as the representative photovoltaic module 171, of the first set of photovoltaic modules 170 without the longitudinally extending edge portions 172a, 172b being affixed, by either bolting or clamping, to the first and second support arms 510, 530. Similarly, longitudinally extending edge portions of the modules of the second set of photovoltaic modules 180 may similarly rest on (without being affixed to by, for example, bolting or clamping) the third and fourth support arms 560, 580 of the second module support member 550. As such, the third and fourth support arms 560, 580 engage and support the respective longitudinally extending edge portions of the photovoltaic modules of the second set of photovoltaic modules 180 without the longitudinally extending edge portions being affixed, by either bolting or clamping, to the third and fourth support arms 560, 580. Additionally, for cost-saving purposes, in such a configuration, one or more of the first and second support arms 510, 530 of the first module support member 500 and the third and fourth support arms 560, 580 of the second modules support member 550 may simply be eliminated from the mounting bracket assembly 200. For example, the interior support arms, i.e., the second support arm 530 of the first module support member 500 and the fourth support arm 580 of the second module support member 550 may be eliminated for cost saving purposes. It is within the scope of the mounting bracket assembly of the present disclosure to include and encompass all such modifications discussed above, as well as other modifications of the disclosed mounting bracket assembly that would be recognized by those of skill in the art.

Transport Configuration 950 and Assembled Configuration 900

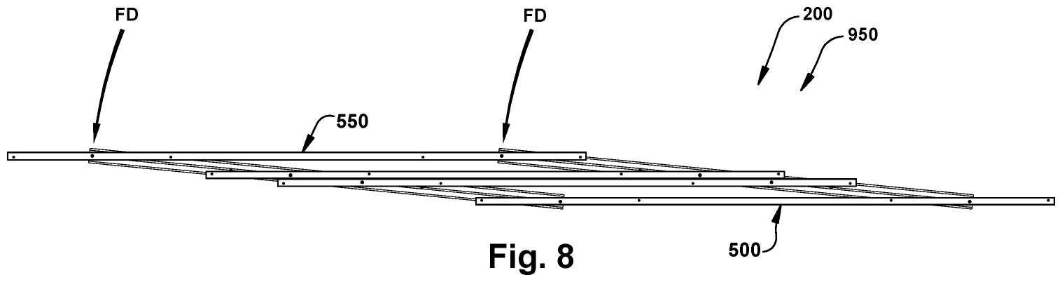

As best seen in a comparison of FIGS. 7 and 8, advantageously, the mounting bracket assembly 200 of the present disclosure can be partially assembled at the factory and transported to an installation site of the solar tracker system 100 in a partially folded or transport configuration 950 (FIG. 8). The advantage of the partial assembly of the mounting bracket 200 at the factory, as compared to full assembly of the mounting bracket assembly 200 at a remote installation site is significant. Typically, labor costs at a remote installation site are significantly higher than at the factory, thus, every component of the mounting bracket assembly 200 that can be preassembled at the factory, as opposed to assembly of those components in the field, represents a significant cost reduction to the purchaser. Additionally, in the transport configuration 950, the mounting bracket assembly 200 is a reduced sized configuration, this smaller footprint or volume of the mounting bracket assembly 200 advantageously provides for storage and transportation efficiencies. To facilitate folding the mounting bracket assembly 200 to the transport configuration 950 at the factory, the first and second sets of connectors 630, 680 are assembled loosely such that the second support arm 530 of the first module support member 500 and the fourth support arm 580 of the second module support member 550 are sufficiently loose to permit pivoting of the second support arm 530 and the fourth support arm 580 with respect to the first and second mounting brackets 400, 450.

Additionally, two peripheral connectors 700 (FIG. 7) which couple the first support arm 510 of the first module support member 500 to respective end portions 440, 490 of the first and second mounting brackets 400, 450 and two additional peripheral connectors 720 which couple the third support arm 560 of the second module support member 550 to respective end portions 440, 490 of the first and second mounting brackets 400, 450 are assembled at the factory with sufficient looseness to permit pivoting of the first support arm 510 and the third support arm 560 with respect to the first and second mounting brackets 400, 450. This permits pivoting the first, second, third and fourth support arms 510, 530, 560, 580 of the first and second module support members 500, 550 with respect to the first and second mounting brackets 400, 450 to achieve the folded or transport configuration 950 of the mounting bracket assembly 200 by applying force to the third support arm 560 of the second module support member 550 in a folding direction (labeled FD in FIG. 8). Once the mounting bracket assembly 200 is at the installation site, the mounting bracket assembly 200 is pivoted from the folded or transport configuration 950 to its open or assembled condition 900 and the first and second sets of connectors 630, 680 and the four peripheral connectors 700, 720 are fastened or tightened to lock the mounting bracket assembly 200 in the assembled configuration 900 and to further affix or secure the mounting bracket assembly 200 to the torque tube beam 120.

It should be understood and appreciated that while the mounting bracket assembly 200 of the present disclosure is configured to support first and second sets of bifacial photovoltaic modules 170, 180 in landscape orientation with the gap G between opposing or facing edges of the first and second sets of modules 170, 180, the mounting bracket assembly 200 may also be used for supporting other types of photovoltaic modules or solar panels including, but not limited to, monofacial photovoltaic modules and/or supporting various combinations of photovoltaic modules or solar panels in a solar tracker assembly or system.

### Second Exemplary Embodiment—Mounting Bracket Assembly 1200

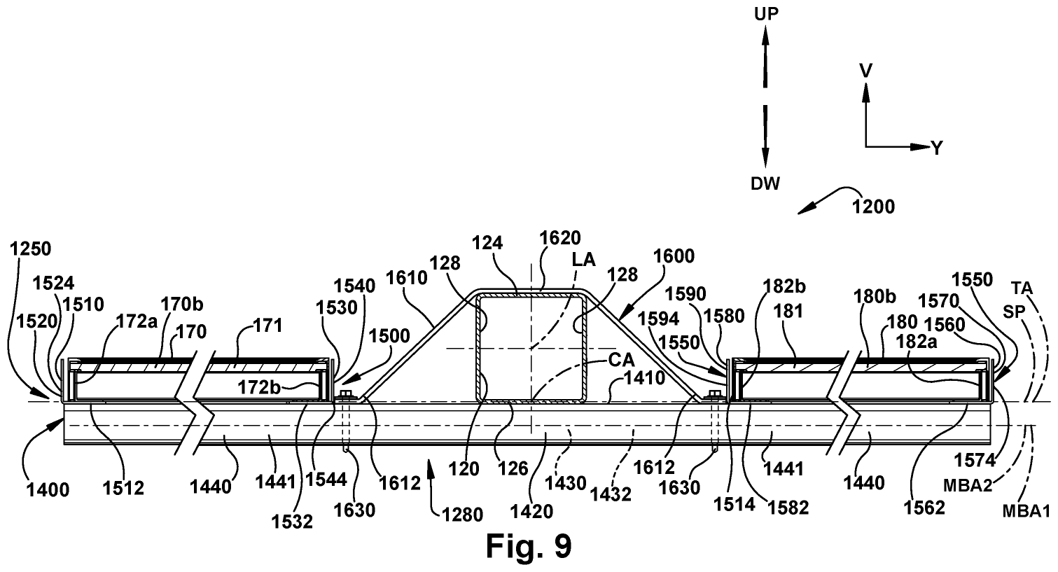

A second exemplary embodiment of the mounting bracket assembly of the present disclosure is shown generally at 1200 in FIG. 9. The components of the mounting bracket assembly 1200 are similar in structure to the corresponding components of the mounting bracket assembly 200 of the first embodiment and, for brevity, will not be discussed in detail, reference being made to the prior discussion of the mounting bracket assembly 200. One of the differences between the mounting bracket assembly 200 and the mounting bracket assembly 1200 is that the mounting bracket assembly 200 of the first exemplary embodiment was affixed to the torque tube beam 120 by the first and second securement members 600, 650 of the attachment structure 280 such that the first and second base members 300, 350 and the first and second mounting brackets 400, 450 were positioned and mounted on the upper wall 124 of the torque tube beam 120. This can best be seen, for example, in FIGS. 3, 3A and 4. By contrast, in the mounting bracket assembly 1200 of the second exemplary embodiment, first and second base members and first and second mounting brackets are mounted to the torque tube beam 120 such that the first and second base members and the first and second mounting brackets are positioned and mounted on or to the lower wall 126 of the torque tube beam 120. Only the first mounting bracket 1450 of the mounting bracket assembly 1200 is schematically depicted in the front elevation view of FIG. 9. However, the first and second base members of the mounting bracket assembly 1200 of the second exemplary embodiment are similar in structure and function to the first and second base members 300, 350 of the mounting bracket assembly 200 of the first exemplary embodiment and the first and second mounting brackets of the mounting bracket assembly 1200 of the second exemplary embodiment are similar in structure and function to the first and second mounting brackets 400, 450 of the mounting bracket assembly 200 of the first exemplary embodiment. Specifically, the first base member of the attachment structure 1280 of the mounting bracket assembly 1200 interfits in a nested configuration 1432 within an upright oriented u-shaped opening 1430 defined by upper wall and side walls of the first mounting bracket 1400. Similarly, although not shown, the second base member interfits in a nested configuration or relationship within an inverted u-shaped opening defined by upper wall and side walls of the second mounting bracket.

With respect to the attachment structure 1280 of the mounting bracket assembly 1200, the first and second base members and first and second mounting brackets extend along respective first and second mounting bracket axes MBA1, MBA2 that are horizontal and orthogonal to a central axis CA of the mounting bracket assembly 1200 and parallel to a transverse axis TA. In the mounting bracket assembly 1200, the central axis CA and the transverse axis TA intersect and lie within a support plane SP of the mounting bracket assembly 1200. With respect to vertical position, the first and second mounting bracket axes MBA1, MBA2 are disposed below, that is vertically downward DW, of the central and transverse axes CA, TA of the mounting bracket assembly 200 and also below, that is vertically downward DW, of the torque tube beam longitudinal axis LA. As can be seen in FIG. 9, the positioning of the first and second base members and first and second mounting brackets below the lower wall 126 of the torque tube beam 120 results in the first and second sets of photovoltaic modules 170, 180, as well as the module support framework 1250, including the first and second module support members 1500, 1550, being positioned in the vertical direction V, between the upper and lower walls 124, 126 of the torque tube beam 120. The “below the torque tube beam” mounting configuration of the mounting bracket assembly 1200 of the second exemplary embodiment is advantageous in that it brings the solar tracker system 100 closer to a desirable balance position wherein, as measured with respect to the vertical axis, a center of gravity of the table 110 of the solar tracker assembly 100 is close to a vertical position of an axis of rotation of the table 100. A “balanced” configuration of the table 110 is advantageous in that a balanced table requires less torque and accordingly less energy to pivot the table, as compared to an unbalanced table. The table of the solar tracker assembly includes all the pivoting or moving parts of the solar tracker assembly 100 (including moving parts of the actuator mechanism, the torque tube beam, the moving parts of the solar tracker bearing apparatuses, the mounting bracket assemblies and the first and second sets of bifacial photovoltaic modules. A shortcoming of the “below the torque tube beam” mounting configuration of the mounting bracket assembly 1200 is that in the early and late parts of the day, when the sun is just rising above the horizon or just setting, the projection of the side walls 128 and upper wall 124 of the torque tube beam 120 will tend to shade portions of the upper surfaces of first and second sets of photovoltaic modules 170, 180, even with the table at its maximum angles of inclination. This is referred to as undesired “shading” of the photovoltaic modules at near sunrise and near sunset periods.

In one exemplary embodiment, the mounting bracket assembly 1200 of the second exemplary embodiment includes a module support framework 1250, for supporting first and second sets of photovoltaic modules 170, 180 in spaced apart relationship on opposite sides of the torque tube beam 120, as viewed in top plan view, and an attachment structure 1280, for coupling the module support framework 1250 to the torque tube beam 120. The module support framework 1250 includes first and second module support members 1500, 1550, which are similar in structure and function to the first and second module support members 500, 550 of the module support framework 250 of the mounting bracket assembly 200 of the first exemplary embodiment. In one exemplary embodiment, the first module support member 1500 includes a first support arm 1520, an extending end 1524 can be seen in FIG. 9, and a second support arm 1530, an extending end 1544 can be seen in FIG. 9. The first support arm 1520 includes a horizontal base 1512, which engages and supports longitudinally extending edge portion 172a of the representative photovoltaic module 171 (which, in the depiction of FIG. 9 is module 170b) of the first set of photovoltaic modules 170, and a vertically extending ledge 1520 extending upwardly from the horizontal base 1512. Similarly, the second support arm 1530 includes a horizontal base 1532, which engages and supports longitudinally extending edge portion 172b of the representative photovoltaic module 171 (which, in the depiction of FIG. 9 is module 170b) of the first set of photovoltaic modules 170, and a vertically extending ledge 1540 extending upwardly from the horizontal base 1532.

In one exemplary embodiment, the second module support member 1550 includes a third support arm 1560, an extending end 1574 can be seen in FIG. 9, and a fourth support arm 1580, an extending end 1594 can be seen in FIG. 9. The third support arm 1560 includes a horizontal base 1562, which engages and supports longitudinally extending edge portion 182a of the representative photovoltaic module 181 (which, in the depiction of FIG. 9 is module 180b) of the second set of photovoltaic modules 180, and a vertically extending ledge 1570 extending upwardly from the horizontal base 1562. Similarly, the fourth support arm 1580 includes a horizontal base 1582, which engages and supports longitudinally extending edge portion 182b of the representative photovoltaic module 181 (which, in the depiction of FIG. 9 is module 180b) of the second set of photovoltaic modules 180, and a vertically extending ledge 1590 extending upwardly from the horizontal base 1582.

In one exemplary embodiment, the attachment structure 1280 includes the first and second base members, the first and second mounting brackets, which respectively receive the first and second base members in nested relationship 1432, and first and second securement members (only securement member 1600 is schematically depicted in FIG. 9) for securing or coupling the module support framework 1250 (and the first and second sets of photovoltaic modules 170, 180 mounted thereto) to the lower wall 126 of the torque tube beam 120. As only the first mounting bracket 1400 is schematically depicted in FIG. 9, only the first mounting bracket 1400 will be discussed, appreciating that the second mounting bracket is similar in structure and function. The first mounting bracket 1400 includes an upper wall 1410 and first and second side walls 1420 extending downwardly from the upper wall 1410, the first and second side walls 1420 each includes horizontal end portions. The upper wall 1410 of the first mounting bracket 1400 bears against the lower wall 126 of the torque tube beam 120. The upper wall 1410 also bears against and supports the respective horizontal bases 512, 532, 562, 582 of the first and second module support members 500, 550. The upper wall 1410 and the first and second side walls 1420 define the upright u-shaped opening 1430. The upright u-shaped opening 1430 of the first mounting bracket 400 receives the first base member in a nested relationship 1432. Looking along a length of the first mounting bracket 1400, the first mounting bracket 1400 includes first and second end portions 1440 spaced apart by a central portion 1441.

In one exemplary embodiment, the first securement member 1600 of the attachment structure 1280 includes a strap 1610. The strap 1610 includes end portions 1612 with openings. The openings at opposite end portions 1612 of the strap 1610 receive a first pair of connectors 1630. Each connector of the first pair of connectors 1630 includes a threaded fastener body and associated mating nuts. The threaded fastener body passes through aligned openings of: a) the end portions 1612 of the strap 1610; b) a lower wall of the first base member; and c) a recessed central region of the upper wall 1410 of the first mounting bracket 1400. When the strap 1610 of the first securement member 1600 is tightened against the upper wall 124 of the torque tube beam 120 by the first pair of connectors 1630: a) the strap 1610 bears against the upper wall 124 of the torque tube beam 120; b) the upper wall 1410 of the first mounting bracket 400 bear against the lower wall 126 of the torque tube beam 120; and c) the upper ends of side walls of the first base member bears against the upper wall 1410 of the first mounting bracket 1400. Additionally, when the strap 1610 of the first securement member 1600 is tightened against the upper wall 124 of the torque tube beam 120 by the first pair of connectors 1630, both the horizontal base 1532 of the second support arm 1530 of the first module support member 1500 and the horizontal base 1582 of the fourth support arm 1580 of the second module support member 1550 are secured to and bear against the upper wall 1410 of the first mounting bracket 1400 to thereby secure the first and second module support members 1500, 1550 to the first mounting bracket 1400 and thereby securely couple the first and second module support members 1500, 1550 (along with the first and second sets of photovoltaic modules 170, 180 supported by the support members 500, 550) to the torque tube beam 120. While the second securement member of the attachment structure 1280 is not shown in FIG. 9 is not shown, it has a similar configuration and structure as the first securement member 1600, as described above.

### Third Exemplary Embodiment—Mounting Bracket Assembly 2200

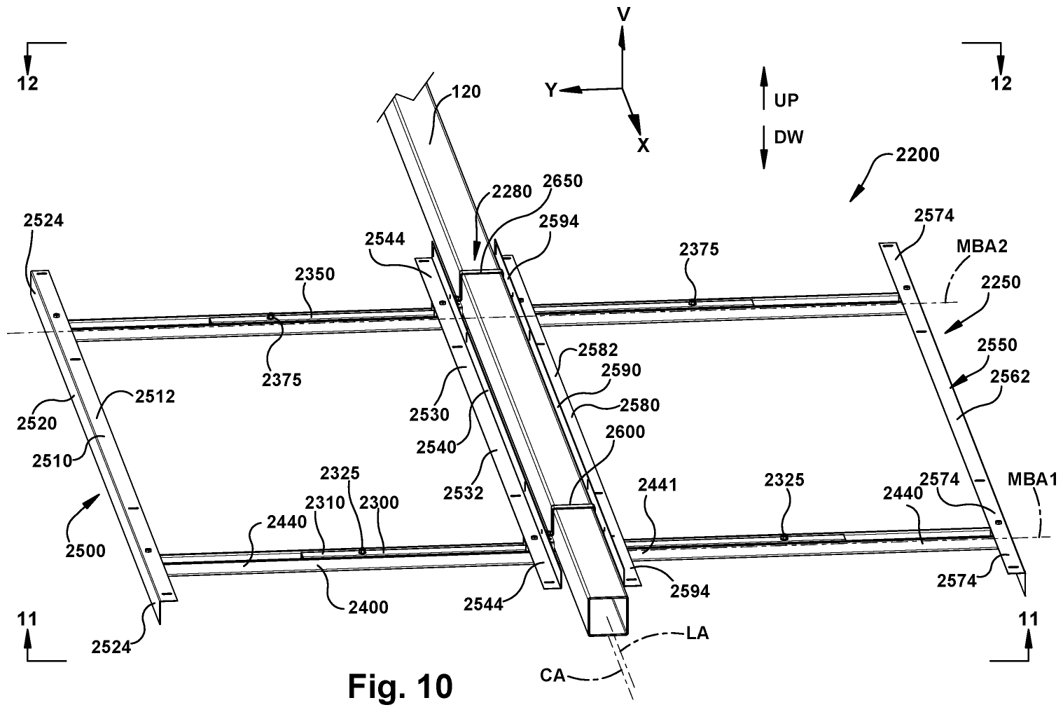

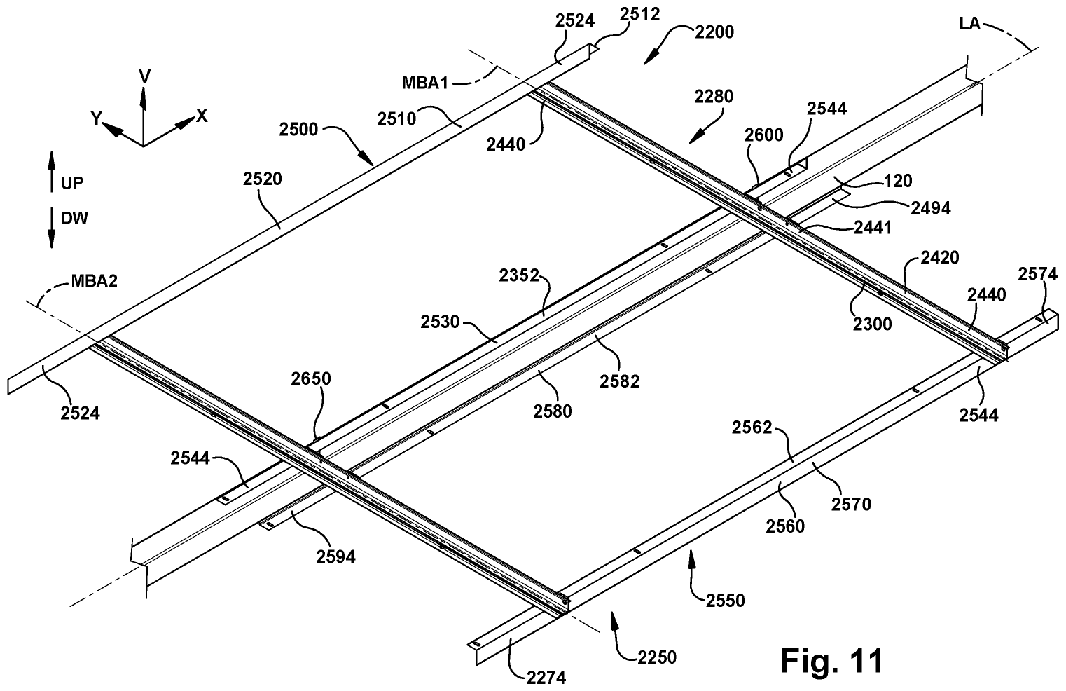

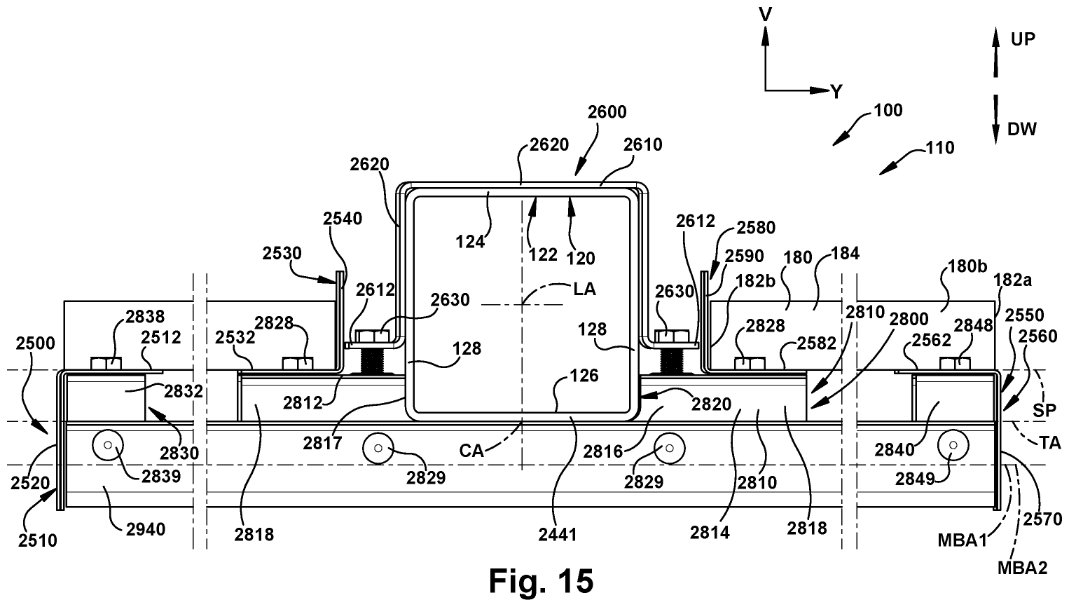

A third exemplary embodiment of the mounting bracket assembly of the present disclosure is shown generally at 2200 in FIGS. 10-17. The mounting bracket assembly 2200 is a “below the torque tube beam” mounting configuration that is generally similar to the mounting bracket assembly 1200 of the second exemplary embodiment. Specifically, in the mounting bracket assembly 1200, the first and second base members 2300, 2350 and first and second mounting brackets 2400, 2450 are mounted to the torque tube beam 120 such that the first and second base members 2300, 2350 and the first and second mounting brackets 2400, 2450 are positioned below and mounted or secured to the lower wall 126 of the torque tube beam 120. The components of the mounting bracket assembly 2200 are similar in structure to the corresponding components of the mounting bracket assembly 200 of the first embodiment and the mounting bracket assembly 1200 of the second embodiment and, for brevity, will not be discussed in detail, reference being made to the prior discussion of the mounting bracket assemblies 200, 1200.

As mentioned in connection with the mounting bracket assembly 1200 of the second exemplary embodiment, a shortcoming of the “below the torque tube beam” mounting configuration of the mounting bracket assembly 1200 is that in the early and later parts of the day, when the sun is near the horizon, the projection of the side walls 128 and upper wall 124 of the torque tube beam 120 will tend to shade portions of the upper surfaces of first and second sets of photovoltaic modules 170, 180, even with the table at its maximum angles of inclination. To mitigate, at least to a degree, the aforementioned “shading” issue and, additionally and advantageously, to bring the solar tracker system 100 closer to the desirable balanced position by raising a center of gravity of the table 110 of the solar tracker assembly 100, as necessary, such that the table center of gravity, as measured with respect to the vertical axis, is closer to the vertical position of the axis of rotation of the table 100, in the mounting bracket assembly 2400 of the third exemplary embodiment, an intermediate spacer assembly or pedestal assembly 2800 is provided to effectively vertically raise or lift the first and second sets of photovoltaic modules 170, 180, with respect to the upper wall 124 of the torque tube beam 120. The pedestal assembly 2800, in one exemplary embodiment, includes: a) a first set of pedestals 2805 interposed between the first mounting bracket 2400 and the respective horizontal bases 2512, 2532 of the first and second support arms 2510, 2530 of the first module support member 2500 and the horizontal bases 2562, 2582 of the third and fourth support arms 2560, 2580 of the second module support member 2550; and b) a second set of pedestals 2855 interposed between the second mounting bracket 2450 and the horizontal bases 2512, 2532 of the first and second support arms 2510, 2530 of the first module support member 2500 and the horizontal bases 2562, 2582 of the third and fourth support arms 2560, 2580 of the second module support member 2550. Advantageously, the pedestal assembly 2800 has the effect of vertically raising the upper surfaces of the first and second set of photovoltaic modules 170, 180 with respect to the torque tube beam 120, thereby mitigating the shading effect at near sunrise and near sunset time periods and also has the effect of vertically raising the center of gravity of the table 100, as necessary, to bring the solar tracker assembly 100 closer to a balanced condition.

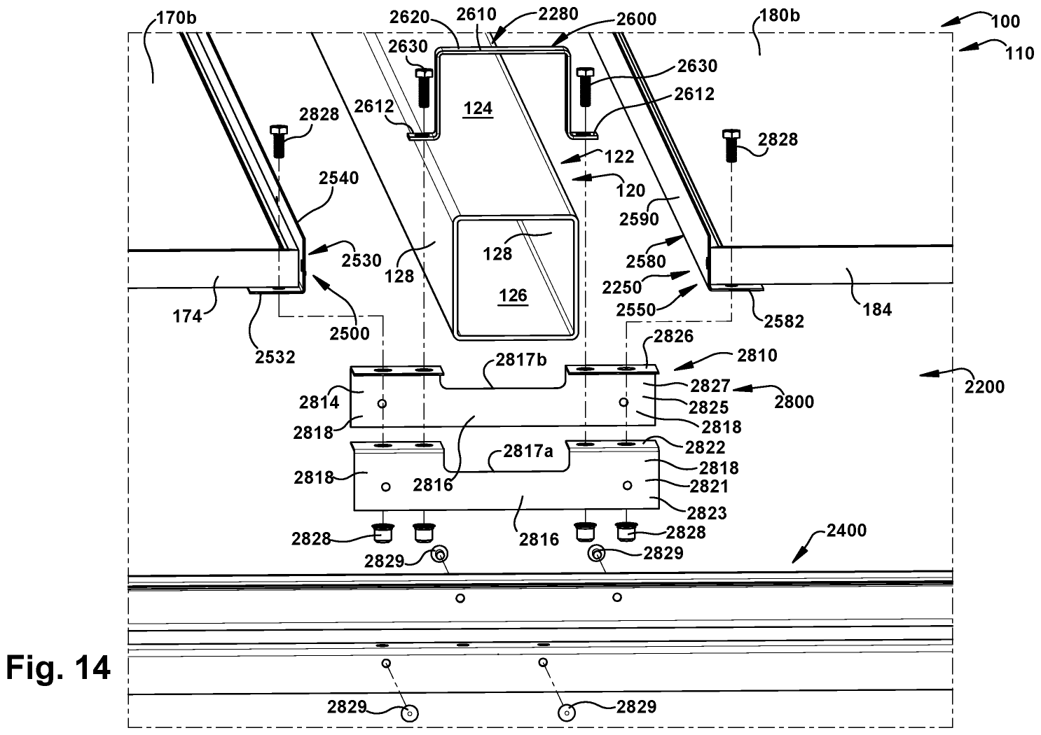

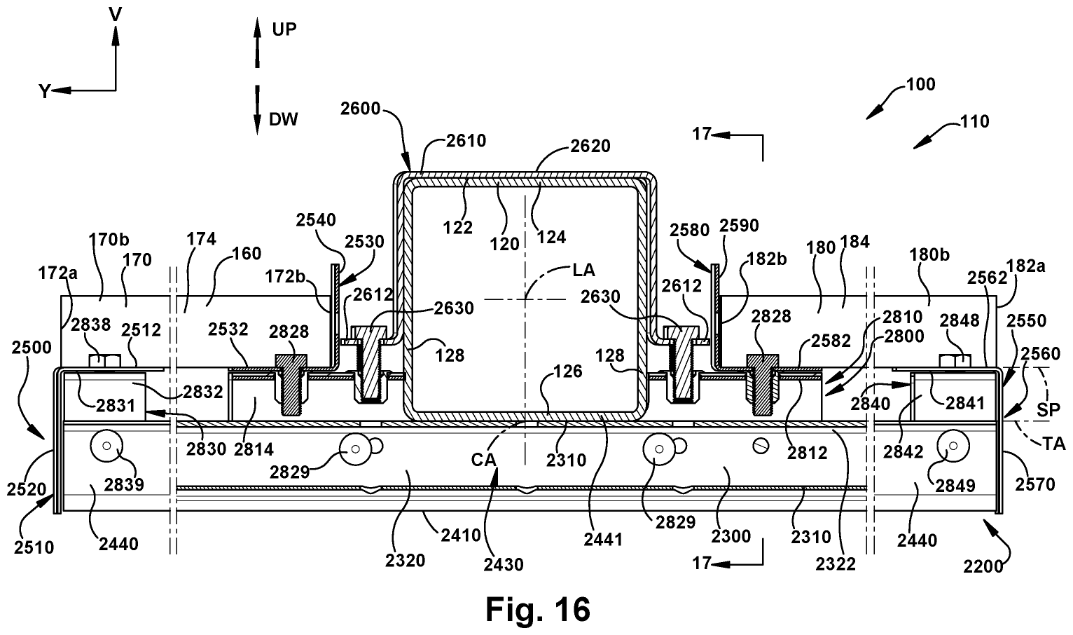

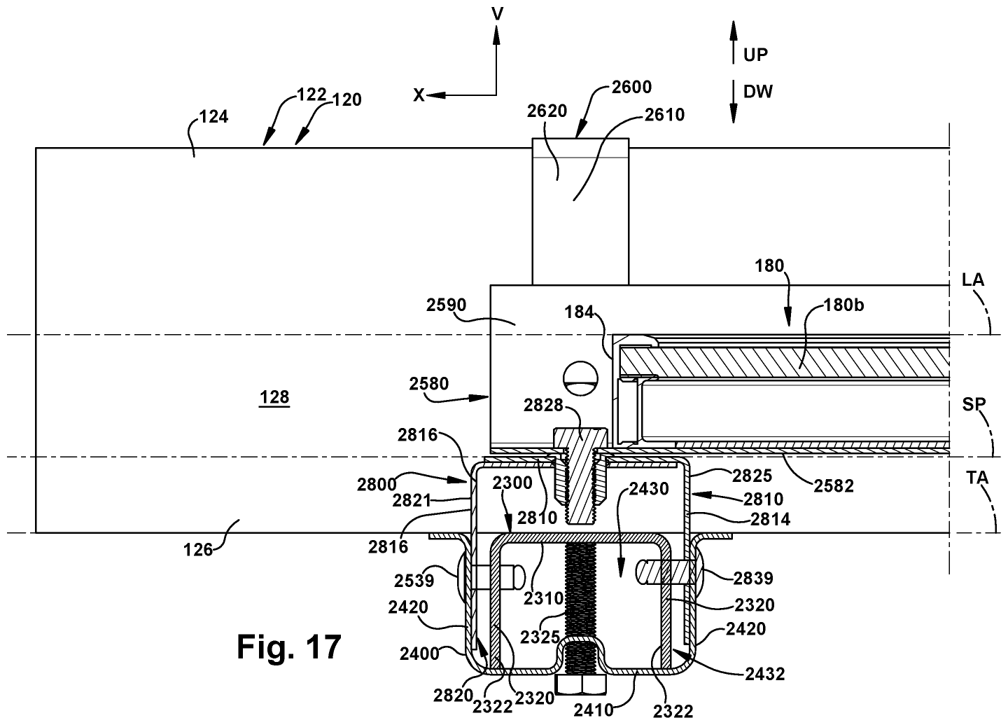

The first set of pedestals 2805 include a first central pedestal 2810, a first edge pedestal 2830, and a second edge pedestal 2850. The first central pedestal 2810 includes a generally planar upper or central wall 2812 and a pair of laterally extending side or lateral walls 2814 extending downwardly from the central wall 2812. The first central pedestal 2810 includes a central or middle portion 2816 and extending side portions 2818. As best seen in FIG. 16, the central wall 2812 and the lateral or side walls 2814 in the central or middle portion 2816 of the first central pedestal 2810 includes an upper cutout 2817, which is configured to receive and engage a lower portion of the torque tube beam 120. The lower portion of the torque tube beam 120 includes the lower wall 126 and lower portions of the side walls 128, which are received in the lower cutout 2817 in a nested relationship 2810. The first central pedestal 2810 is secured to the torque tube beam 120 by the strap 2610 of the first securement member 2600. As best seen in FIG. 14, a pair of vertically oriented fasteners 2630 pass through aligned openings in end portions 2612 of the strap 2610 and the upper wall 2812 of the first central pedestal 2810. The first mounting bracket 2810, in turn, is affixed to the lateral walls 2814 of the first central pedestal 2810 by a set of horizontally oriented connectors or fasteners 2829 which pass through aligned openings in the lateral walls 2814 of the first central pedestal 2810 and side walls 2420 of the first mounting bracket 2400. The horizontal bases 2532, 2582 of the second and fourth support arms 2530, 2580 are, in turn, are affixed to the upper wall 2812 of the first central pedestal 2810 by a pair of vertically oriented fasteners 2828 that pass through aligned openings in the upper wall 2812 of the first central pedestal 2810 and the horizontal bases 2532, 2582 of the second and fourth support arms 2530, 2580. Additionally, the first base member 2300 is secured to mounting bracket 2400 by the vertically oriented fasteners 2630 passing through end portions 2612 of the strap 2610 of the first securement member 2600 and by a plurality of threaded fasteners 2325, which can be seen in the schematic depictions of FIGS. 10 and 17. Similarly, the second base member 2350 is secured to the second mounting bracket 2450 by vertically oriented fasteners passing through end portions of a strap 2650 (FIG. 10) of a second securement member and by a plurality of threaded fasteners 2375, similar to the plurality of threaded fasteners 2375.

In one exemplary embodiment, the first central pedestal 2810 comprises a two-part structure including matching, overlapping first and second members 2821, 2825. The first member 2821 includes an upper wall 2822 and a side wall 2823 extending from the upper wall 2823. The upper and side walls 2822, 2823 include an upper cutout 2817a, which defines a part of the cutout 2817. The second member 2825 also includes an upper wall 2826 and a side wall 2827 extending from the upper wall 2826. The upper and side walls 2826, 2827 include an upper cutout 2817b, which defines a part of the cutout 2817. As can best be seen in the section view of FIG. 17, the respective upper walls 2822, 2826 are in overlapping vertical configuration when the mounting bracket assembly 2200 is assembled. In one exemplary embodiment, the pair of vertically oriented fasteners 2828 may comprise a bolt-rivet nut combination, with the rivet nut of the combination functioning to affix the overlapping first and second members 2821, 2825 of the first central pedestal 2810.

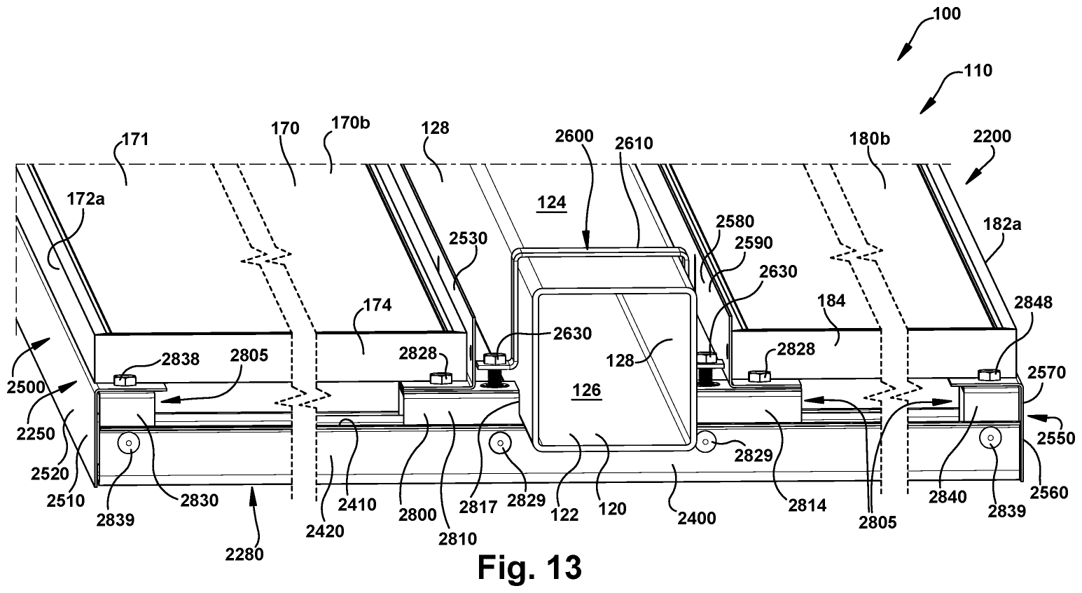

The first set of pedestals 2800 also include the first edge pedestal 2830 and the second edge pedestal 2850. The first edge pedestal 2830 includes an upper wall 2831 and a pair of downwardly extending lateral side walls 2832 and is positioned between the horizontal base 2512 of the first support arm 2510 and the first mounting bracket 2400. As best seen in FIG. 13, the first mounting bracket 2810, is affixed to the side walls 2832 of the first edge pedestal 2830 by a set of horizontally oriented connectors or fasteners 2838 which pass through aligned openings in the side walls 2832 of the first edge pedestal 2830 and side walls 2420 of the first mounting bracket 2400. The horizontal base 2512 of the first support arm 2510 is affixed to the upper wall 2831 of the first edge pedestal 2830 by a vertically oriented fastener 2838 that passes through aligned openings in the upper wall 2831 of the first edge pedestal 2810 and the horizontal base 2512 of the first support arm 2510. The second edge pedestal 2840 includes an upper wall 2841 and a pair of side walls 2842 and is positioned between the horizontal base 2562 of the third support arm 2510 of the second module support member 2550 and the first mounting bracket 2400. As best seen in FIG. 13, the first mounting bracket 2810, is affixed to the side walls 2842 of the second edge pedestal 2840 by a set of horizontally oriented connectors or fasteners 2848 which pass through aligned openings in the side walls 2842 of the second edge pedestal 2840 and side walls 2420 of the first mounting bracket 2400. The horizontal base 2562 of the third support arm 2560 is affixed to the upper wall 2841 of the second edge pedestal 2830 by a vertically oriented fastener 2848 that passes through aligned openings in the upper wall 2841 of the second edge pedestal 2840 and horizontal base 2562 of the third support arm 2560.

Of course, it should be appreciated that the pedestal assembly 2800 includes the second set of pedestals 2855 for the second mounting bracket 2450. The second set of pedestals 2855 are similar in configuration and function to the first set of pedestals 2805, except that the second set of pedestals 2855 are used in conjunction with the second mounting bracket 2450. The second set of pedestals 2855 are affixed to the second mounting bracket 2450 and the support arms 2510, 2530, 2560, 2580, as described with respect to the first of pedestals 2805 and the first mounting bracket 2400. The second set of pedestals 2855 include: a) a second central pedestal, substantially identical in configuration and function to the first central pedestal 2810, and b) third and fourth edge pedestals, substantially identical in configuration and function to the first and second edge pedestals 2830, 2840, respectively.

The schematic depiction of the mounting bracket assembly 2200 shown in FIGS. 13-17 is modified in that the first, second, third and fourth support arms 2510, 2530, 2560, 2580 are truncated at the first mounting bracket 2400 to better illustrate the configuration of the first set of pedestals 2805 and the fasteners/connectors used to secure the first mounting bracket 2400 and the support arms 2510, 2530, 2560, 2580 to the first central pedestal 2810 and the first and second edge pedestals 2810, 2840. The truncated version of the mounted bracket assembly 2200, as schematically depicted in FIGS. 13-17, would be used, for example at the respective ends of a row or set of bifacial photovoltaic modules, since there would be no need for extending portions of the first, second, third and fourth support arms 2510, 2530, 2560, 2580 at the end of a row of photovoltaic modules, for example, at the end of the two rows of photovoltaic modules 170, 180 which are schematically illustrated in FIGS. 1 and 2.

Referring to FIGS. 10-12 and 17, in one exemplary embodiment, the mounting bracket assembly 2200 includes an attachment structure 2280 includes a first base member 2300 received in a nested relationship 2432 within an upright u-shaped opening 2430 of the first mounting bracket 2400. The first base member includes a central wall 2310 and first and second side walls 2320 extending from the opposite ends of the central wall 2310. As can best be seen in FIG. 17, end portions 2322 of the first and second side walls 2320 bear against a central wall 2410 of the first mounting bracket. A plurality of fasteners affix the first base member 2300 to the first mounting bracket 2400 within the u-shaped opening 2430 of the first mounting bracket 2400. The first mounting bracket 2400 includes the central wall 2410 and first and second side walls 2420 which extending from opposite ends of the central wall 2310. The first and second side walls 2420 are substantially parallel with each other and are substantially parallel to the first mounting bracket axis MBA1. The central wall 2410 and the first and second side walls 2420 define the upright u-shaped opening 2430 of the first mounting bracket. The first mounting bracket 2410 includes a central portion or region 2441, which receives the first base member 2300 and the first central pedestal 2810 of the first set of pedestals 2805 of the pedestal assembly 2800, and a pair of first and second end portions 2440, which respectively receive the first and second edge pedestals 2830, 2840 of the first set of pedestals 2805 and first support mark 3510 of the first module support member 3500 and the third module support member 3550 of the second module support member 3550. The second mounting bracket 2450 and the second base member 2350, which are part of the attachment structure 2280, are substantially identical in configuration and function to the first mounting bracket 2400 and the first base member 2300. The first and second side walls of the second mounting bracket 2450 are substantially parallel with each other and are substantially parallel to the second mounting bracket axis MBA2.

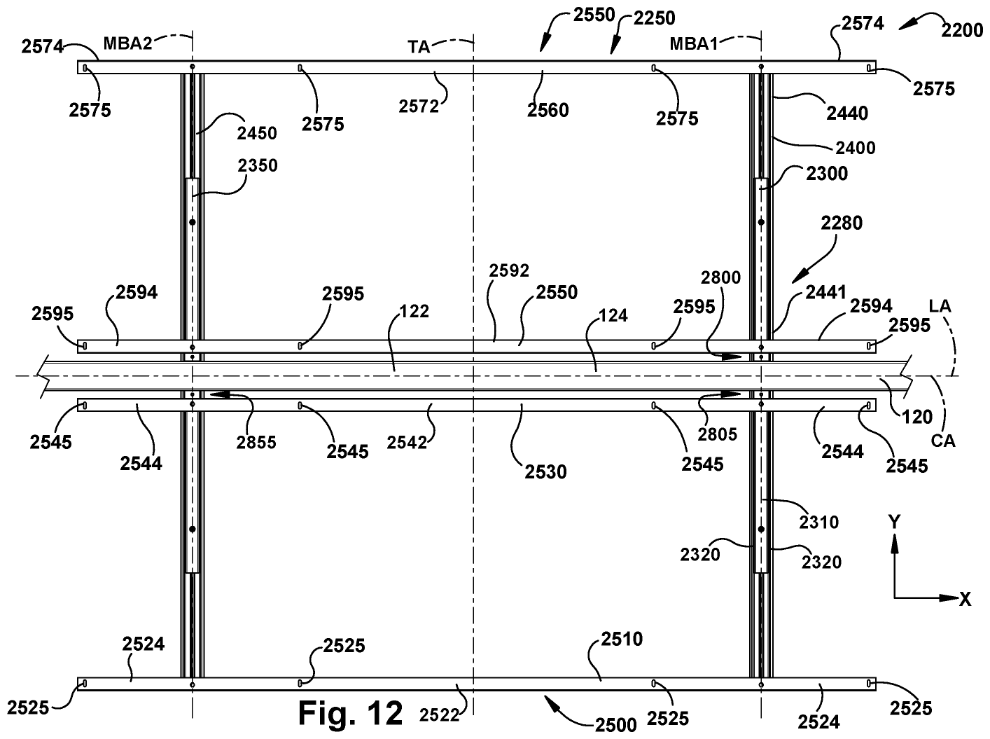

In one exemplary embodiment, the mounting bracket assembly 2200 includes a module support framework 2250, including first and second module support members 2500, 2550. As can best be seen in FIGS. 10-12, the first module support member 2500 includes the first support arm 2510 affixed to the upper wall 2831 of the first edge pedestal 2830 and the second support arm 2530 affixed to the upper wall 2812 of the first central pedestal 2810. The first support arm 2510 includes the horizontal base 2512 and a downwardly extending vertical ledge 2520 extending from an outer edge of the base 2512. The second support arm 2530 includes the horizontal base 2532 and an upwardly extending vertical ledge 2540 extending from the horizontal base 2532. The downwardly extending vertical ledge 2520 of the first support arm 2510 facilitates loading of the first set of photovoltaic modules 170 onto the first module support member 2500 of the module support framework 2250 during assembly of the solar tracker assembly 100 in the field by eliminating the need to lift the modules of the first set of photovoltaic modules 170 over an upwardly extending vertical ledge or lip of the first support arm 2510. Instead, the modules of the first set of modules 170 can simply be place on the horizontal base 2512 of the first support arm 2510 and slid inwardly toward the second support arm 2530 until the module contacts the upwardly extending vertical ledge 2540 of the second support arm 2530. The modules of the first set of modules 170 are then secured in place by a plurality of fasteners that extend through a plurality of openings 2525 spaced along the horizontal base 2512 of the first support arm 2510 and a plurality of openings 2545 spaced along the horizontal base 2532 of the second support arm 2530. As best seen in FIG. 12, the first support arm 2510 includes a central portion 2522 that spans the first and second mounting brackets 2400, 2450 and extending ends or end portions 2524 that extend beyond the first and second mounting brackets 2400, 2450, while the second support arm 2530 likewise includes a central portion 2522 that spans the first and second mounting brackets 2400, 2450 and extending ends 2544 that extend beyond the first and second mounting brackets 2400, 2450.

Similarly, the second module support member 2550 includes the third support arm 2560 affixed to the upper wall 2841 of the second edge pedestal 2840 and the fourth support arm 2580 affixed to the upper wall 2812 of the first central pedestal 2810. The third support arm 2560 includes the horizontal base 2562 and a downwardly extending vertical ledge 2570 extending from an outer edge of the base 2562. The fourth support arm 2580 includes the horizontal base 2582 and an upwardly extending vertical ledge 2590 extending from the horizontal base 2582. The downwardly extending vertical ledge 2570 of the third support arm 2560 facilitates loading of the second set of photovoltaic modules 180 onto the second module support member 2550 of the module support framework 2250 during assembly of the solar tracker assembly 100 in the field by eliminating the need to lift the modules of the second set of modules 180 over an upwardly extending vertical ledge or lip of the third support arm 2560. Instead, the modules of the second set of modules 170 can simply be place on the horizontal base 2562 of the third support arm 2560 and slid inwardly toward the fourth support arm 2580 until the module contacts the upwardly extending vertical ledge 2590 of the fourth support arm 2580. The modules of the second set of modules 180 are then secured in place by a plurality of fasteners that extend through a plurality of openings 2575 spaced along the horizontal base 2562 of the third support arm 2560 and a plurality of openings 2595 spaced along the horizontal base 2582 of the fourth support arm 2580. The third support arm 2560 includes a central portion 2572 that spans the first and second mounting brackets 2400, 2450 and includes extending ends or end portions 2574 that extend beyond the first and second mounting brackets 2400, 2450, while the fourth support arm 2580 similarly includes a central portion 2592 that spans the first and second mounting brackets 2400, 2450 and extending ends or end portions 2594 that extend beyond the first and second mounting brackets 2400, 2450. The central portions 2522, 2542 of the first and second support arms 2510, 2530 between the mounting brackets 2400, 2450 support the entirety of longitudinally extending edge portions 172a, 172b of a module 170a of the first set of photovoltaic modules 170, while the extending ends or end portions 2524, 2544 of the first and second support arms 2510, 2530, function in combination with directly adjacent mounting assemblies of the solar tracker system 100, to support portions of longitudinally extending edge portions of modules 170b, 170c of the first set of photovoltaic modules 170. Similarly, the central portions 2572, 2592 of the third and fourth support arms 2560, 2580 between the mounting brackets 2400, 2450 support the entirety of longitudinally extending edge portions 182a, 182b of modules 180a of the second set of photovoltaic modules 180, while the extending ends or end portions 2574, 2594 of the third and fourth support arms 2560, 2580, function in combination with directly adjacent mounting assemblies of the solar tracker system 100, to support portions of longitudinally extending edge portions of modules 180b, 180c of the second set of photovoltaic modules 180.

### Fourth Exemplary Embodiment—Mounting Bracket Assembly 3200

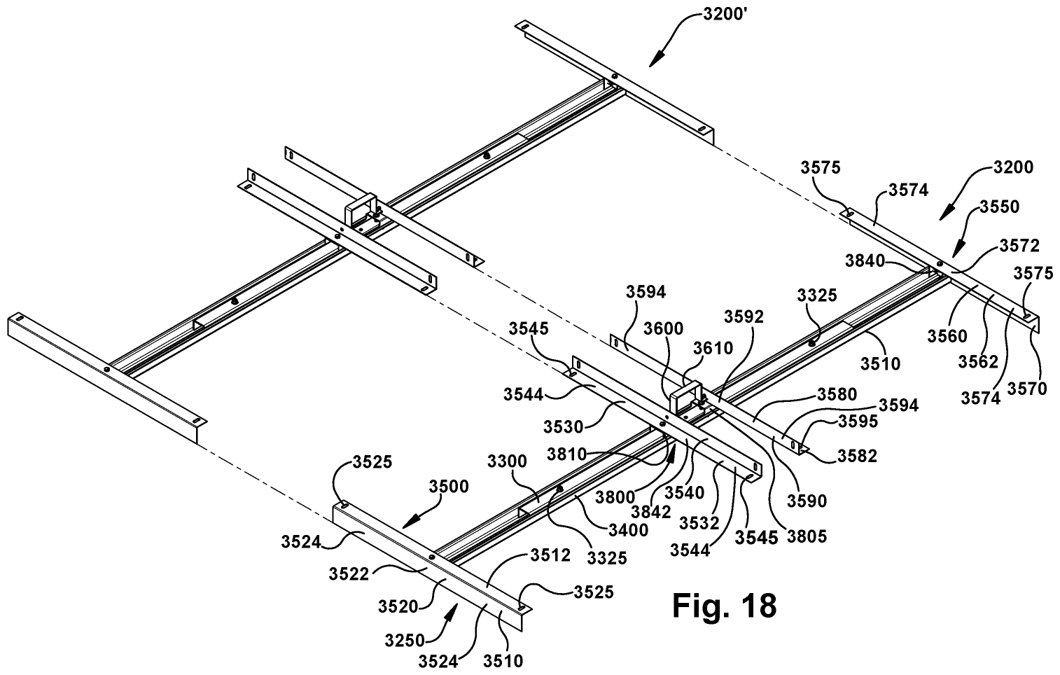

A fourth exemplary embodiment of the mounting bracket assembly of the present disclosure is shown generally at 3200 in FIG. 18. The mounting bracket assembly 3200 is a “below the torque tube beam” mounting configuration that is generally similar to the mounting bracket assembly 2200 of the third exemplary embodiment. The primary difference between the mounting bracket assembly 3200 and the mounting bracket assembly 2200 is with respect to the configuration of the module support framework 3250 and specifically the extent of first and second supports arms 3510, 3530 of a first module support member 3500 and second and third support arms 3560, 3580 of a second module support member 3550 of the module support framework 3250. In the schematic depiction of FIG. 18, two adjacent mounting bracket assemblies 3200 and 3200′ are shown. The mounting bracket assemblies 3200, 3200′ are substantially identical in configuration and function. Accordingly, only the mounting bracket assembly 3200 will be discussed in detail

As can be seen in comparing the schematic depiction of FIGS. 10 and 18, in the mounting bracket assembly 2200 of the third exemplary embodiment, the first and second support arms 2510, 2530 of the first module support member 2500 and the third and fourth support arms 2560, 2580 of the second module support member 2550 span, extend between, and are coupled, via the pedestal assembly 2800, to the first and second mounting brackets 2400, 2450. By contrast, in the mounting bracket assembly 3200 of the fourth exemplary embodiment, the first and second supports arms 3510, 3530 of the first module support member 3500 and the second and third support arms 3560, 3580 of the second module support member 3550 do not span or extend between first and second mounting brackets. Rather, the attachment structure 3280 of the mounting bracket assembly 3200 includes only a single, first mounting bracket 3400 (similar in configuration and function to first mounting bracket 2400 of the mounting bracket assembly 2200), a single, first base 3300 (similar in configuration and function to first base 2300 of the mounting bracket assembly 2200) and a pedestal assembly 3800 having only a single, first set of pedestals 3805 (similar in configuration and function to the first set of pedestals 2805 of the mounting bracket assembly 2200).

In one exemplary embodiment, the mounting bracket assembly 3200 includes the first base 3300, with is received in a nested configuration within an upright, generally u-shaped opening of the defined by a central wall and two substantially parallel side walls of the first mounting bracket 3400. The mounting bracket 3400 includes a central portion 3441 and first and second end portions. The first module support member 3500 of the mounting bracket assembly 3200 includes first and second support arms 3510, 3530 that extend substantially parallel to each other and extend substantially parallel to the central axis CA of the mounting bracket assembly 3200. The first support arm 3510 includes a horizontal base 3512 and a downwardly extending vertical ledge 3520. The downwardly extending vertical ledge 3520 facilitates installation of photovoltaic modules of the first set of photovoltaic modules 170, as previously discussed. The first support arm 3510 further includes a central portion 3522, which is affixed, via a connector, to the first edge pedestal (not shown, but similar in structure and function to the first edge pedestal 2830 of the first set of pedestals 2805 of the mounting bracket assembly 2200 of the third exemplary embodiment) and a pair of end portions 3524 extending from the central portion 3533. The extending edge portions 3524 of the first support arm 3510 extend along and support portions of respective outwardly facing longitudinally extending edge portions 172a of a pair adjacent modules of the first set of photovoltaic modules 170. The second support arm 3530 includes a horizontal base 3532 and an upwardly extending vertical ledge 2540. The second support arm 3530 further includes a central portion 3542, which is affixed, via a connector, to the first central pedestal 3810, and a pair of extending end portions 3544 extending from the central portion 3542. The extending edge portions 3544 of the second support arm 3530 extend along and support portions of respective inwardly facing longitudinally extending edge portions 172b of a pair adjacent modules of the first set of photovoltaic modules 170. The pair of adjacent modules of the first set of modules 170 are then secured in place by a plurality of fasteners that extend through a plurality of openings 3525 spaced along the horizontal base 3512 of the first support arm 3510 and a plurality of openings 3545 spaced along the horizontal base 3532 of the second support arm 3530.

The third support arm 3560 includes a horizontal base 3562 and a downwardly extending vertical ledge 3570. The downwardly extending vertical ledge 3570 facilitates installation of photovoltaic modules of the second set of photovoltaic modules 180, as previously discussed. The third support arm 3560 further includes a central portion 3572, which is affixed, via a connector, to the second edge pedestal 3840 and a pair of extending end portions 3574 extending from the central portion 3572. The extending edge portions 3574 of the third support arm 3560 extend along and support respective portions of outwardly facing longitudinally extending edge portions 182a of a pair adjacent modules of the second set of photovoltaic modules 180. The fourth support arm 3580 includes a horizontal base 3582 and an upwardly extending vertical ledge 2590. The fourth support arm 3580 further includes a central portion 3592, which is affixed, via a connector to the first central pedestal 3810 and a pair of extending end portion 3594. The extending edge portions 3594 of the fourth support arm 3580 extend along and support portions of respective inwardly facing longitudinally extending edge portions 182b of a pair adjacent modules of the second set of photovoltaic modules 180. The pair of adjacent modules of the second set of modules 180 are then secured in place by a plurality of fasteners that extend through a plurality of openings 3575 spaced along the horizontal base 3562 of the third support arm 3560 and a plurality of openings 3595 spaced along the horizontal base 3582 of the second support arm 3580.

Stated another way, facing extending end portions 3524 of respective first arms 3510 of two directly adjacent mounting bracket assemblies, for example, mounting bracket assemblies 3200, 3200′ in FIG. 18, would support portions of the outwardly facing longitudinally extending edge 172a of a photovoltaic module 170a of the first set of photovoltaic modules 170. Facing extending end portions 3544 of the two adjacent mounting bracket assemblies 3200, 3200′ would support portions of the inwardly facing longitudinally extending edge 172b of the photovoltaic module 170a of the first set of photovoltaic modules 170. Facing extending end portions 3574 of the two adjacent mounting bracket assemblies 3200, 3200′ would support portions of the outwardly facing longitudinally extending edge 182a of the photovoltaic module 180a of the second set of photovoltaic modules 180. Facing extending end portions 3594 of the two adjacent mounting bracket assemblies 3200, 3200′ would support portions of the inwardly facing longitudinally extending edge 182b of the photovoltaic module 180a of the second set of photovoltaic modules 180. and facing extending end portions 3574, 3594 of the third and fourth support arms 3560, 3580 of the two directly adjacent mounting bracket assemblies 3200, 3200′ would support portions of the longitudinally extending edges 182a, 182b of a photovoltaic module 180a of the second set of photovoltaic modules 180.

The mounting bracket assembly 3200 includes a strap 3610 of a first securement member of the attachment assembly 3280 of the mounting bracket assembly. End portions of the strap 3610 are affixed, via threaded fasteners, to the first central pedestal 3810, as previously explained with respect to the strap 2610, securing the first central pedestal 3810 and thereby securing the mounting bracket assembly 3200 to the torque tube beam 120.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure/invention. It is, of course, not possible to describe every conceivable combination of components, assemblies, or methodologies for purposes of describing the present disclosure/invention, but one of ordinary skill in the art will recognize that many further combinations and permutations of the present disclosure/invention are possible. Accordingly, the present disclosure/invention is intended to embrace all such alterations, modifications, and variations that fall within the spirit and scope of the appended claims.

What is claimed is:

1. A mounting bracket assembly affixed to a torque tube beam of a solar tracker assembly and supporting longitudinally extending edge portions of first and second photovoltaic modules wherein, when viewed in top plan view, the first photovoltaic module is on a first side of the torque tube beam and the second photovoltaic module is on an opposite side of the torque tube beam and the longitudinally extending edge portions of the first and second photovoltaic modules extend parallel to the torque tube beam, the mounting bracket assembly comprising:
a) a first mounting bracket extending along a first mounting bracket axis extending transverse to the torque tube beam, the first mounting bracket including a central wall and a first and second side walls extending from the central wall, the first mounting bracket having a first end portion, a second end portion and a central portion extending between the first and second end portions;
b) a first set of pedestals including a first central pedestal secured to the torque tube beam including a middle portion engaging the torque tube beam and first and second extending portions on opposite sides of the torque tube beam, the first central pedestal extending along the first mounting bracket axis and including a central wall and a lateral wall extending from the central wall, at least one of the first and second side walls of the first mounting bracket secured to the lateral wall of the first central pedestal;
c) a first module support member including a first support arm and a second support arm, spaced from and extending parallel to the first support arm, the first support arm coupled to the first mounting bracket at the first end portion of the first mounting bracket, the second support arm coupled to the first extending portion of the first central pedestal;
d) a second module support member including a third support arm and a fourth support arm, spaced from and extending parallel to the third support arm, the third support arm coupled to the first mounting bracket at the second end portion of the first mounting bracket, the fourth support arm coupled to the second extending portion of the first central pedestal; and
f) wherein the first and second support arms are configured to support the longitudinally extending edge portions of the first photovoltaic module and the third and fourth support arms are configured to support the longitudinally extending edge portions of the second photovoltaic module.

2. The mounting bracket assembly of claim 1 wherein the central wall and the lateral wall in the middle portion of the first central pedestal includes a cutout which receives a lower portion of the torque tube beam.

3. The mounting bracket assembly of claim 1 wherein the first set of pedestals includes a first edge pedestal disposed between the first support arm of the first module support member and the first mounting bracket and a second edge pedestal disposed between the third support arm of the second module support member and the first mounting bracket.

4. The mounting bracket assembly of claim 1 wherein the lateral wall of the first central pedestal includes first and second side walls extending from opposite ends of the central wall, the first side wall of the first mounting bracket secured to the first side wall of the first central pedestal and the second side wall of the first mounting bracket secured to the second side wall of the first central pedestal.

5. The mounting bracket assembly of claim 1 wherein the first mounting bracket axis, when viewed in top plan view, extends orthogonally to the torque tube beam and further wherein the central wall and the first and second side walls of the first mounting bracket define a u-shaped opening which receives a first base member in a nested relationship.

6. The mounting bracket assembly of claim 5 wherein the first base member includes a central wall and first and second side walls extending from the central wall, the first and second side walls of the first base member engaging the central wall of the first mounting bracket.

7. The mounting bracket assembly of claim 6 wherein the lateral wall of the first central pedestal extends between the first side wall of the first base member and the first side wall of the first mounting bracket.

8. The mounting bracket assembly of claim 2 additionally including a first securement member comprising a strap, the strap including first and second end portions secured to the central wall of the first central pedestal by a pair of fasteners on opposite sides of the first base member and the second securement member comprises a strap including first and second end portions secured to the second base member on opposite sides of the cutout of the first central pedestal.

9. The mounting bracket assembly of claim 1 additionally including a second mounting bracket and a second set of pedestals including a second central pedestal, the second mounting bracket coupled to the torque tube beam and extending along a second mounting bracket axis extending transverse to the torque tube beam, the second mounting bracket including a central wall and a first and second side walls extending from the central wall, the second mounting bracket having a first end portion, a second end portion and a central portion extending between the first and second end portions and the second central pedestal secured to the torque tube beam including a middle portion engaging the torque tube beam and first and second extending portions on opposite sides of the torque tube beam, the second central pedestal extending along the second mounting bracket axis and including a central wall and a lateral wall extending from the central wall, at least one of the first and second side walls of the second mounting bracket secured to the lateral wall of the first central pedestal

10. The mounting bracket assembly of claim 9 wherein the first support arm of the first module support member is coupled to the second mounting bracket at the first end portion of the second mounting bracket and the second support arm of the first module support member is coupled to the first extending portion of the second central pedestal and the third support arm of the second module support member is coupled to the second mounting bracket at the second end portion of the second mounting bracket and the fourth support arm of the second module support member is coupled to the second extending portion of the second central pedestal.

11. A mounting bracket assembly affixed to a torque tube beam of a solar tracker assembly and supporting longitudinally extending edge portions of first and second photovoltaic modules wherein, when viewed in top plan view, the first photovoltaic module is on a first side of the torque tube beam and the second photovoltaic module is on an opposite side of the torque tube beam and the longitudinally extending edge portions of the first and second photovoltaic modules extend parallel to the torque tube beam, the mounting bracket assembly comprising:
a) a first mounting bracket extending along a first mounting bracket axis and a second mounting bracket, spaced from the first mounting bracket, extending along a second mounting bracket axis, the first and second mounting bracket axes extending transversely to the torque tube beam, the first mounting bracket including a central wall and a first side wall extending from the central wall, the first mounting bracket including a first end portion, a second end portion and a middle portion extending between the first and second end portions, the second mounting bracket including a central wall and a first side wall extending from the central wall, the second mounting bracket including a first end portion, a second end portion and a middle portion extending between the first and second end portions;
b) a first set of pedestals including a first central pedestal secured to the torque tube beam including a middle portion engaging the torque tube beam and first and second extending portions on opposite sides of the torque tube beam, the first central pedestal extending along the first mounting bracket axis and including an upper wall and a lateral wall extending from the upper wall, the first side wall of the first mounting bracket secured to the first lateral wall of the first central pedestal;
c) a second set of pedestals including a second central pedestal secured to the torque tube beam including a middle portion engaging the torque tube beam and first and end portions on opposite sides of the torque tube beam, the second central pedestal extending along the second mounting bracket axis and including an upper wall and a first lateral wall, the first side wall of the second mounting bracket secured to the first lateral wall of the second central pedestal;
d) a first module support member including a first support arm and a second support arm, spaced from and extending parallel to the first support arm, the first support arm coupled to the first mounting bracket at the first end portion of the first mounting bracket and coupled to the second mounting bracket at the first end portion of the second mounting bracket, the second support arm coupled to the first extending portion of the first central pedestal and coupled to the first extending portion of the second central pedestal;
e) a second module support member including a third support arm and a fourth support arm, spaced from and extending parallel to the third support arm, the third support arm coupled to the first mounting bracket at the second end portion of the first mounting bracket and coupled to the second mounting bracket at the second end portion of the second mounting bracket, the fourth support arm coupled to the second extending portion of the first central pedestal and coupled to the second extending portion of the second central pedestal; and
f) wherein the first and second support arms are configured to support the longitudinally extending edge portions of the first photovoltaic module and the third and fourth support arms are configured to support the longitudinally extending edge portions of the second photovoltaic module.

12. The mounting bracket assembly of claim 11 wherein the central wall and the lateral wall in the middle portion of the first central pedestal includes a first cutout which receives a lower portion of the torque tube beam and further wherein the central wall and the lateral wall in the middle portion of the second central pedestal includes a second cutout which receives a lower portion of the torque tube beam.

13. The mounting bracket assembly of claim 11 wherein the first set of pedestals includes a first edge pedestal disposed between the first support arm of the first module support member and the first mounting bracket and a second edge pedestal disposed between the third support arm of the second module support member and the second mounting bracket and further wherein the second set of pedestals includes a third edge pedestal disposed between the first support arm of the first module support member and the second mounting bracket and a fourth edge pedestal disposed between the third support arm of the second module support member and the second mounting bracket.

14. The mounting bracket assembly of claim 11 wherein the lateral wall of the first central pedestal includes first and second side walls extending from opposite ends of the central wall and the first mounting bracket includes a second wall extending from the central wall of the first mounting bracket, the first side wall of the first mounting bracket secured to the first side wall of the first central pedestal and the second side wall of the first mounting bracket secured to the second side wall of the first central pedestal and further wherein the lateral wall of the second central pedestal includes first and second side walls extending from opposite ends of the central wall and the second mounting bracket includes a second wall extending from the central wall of the second mounting bracket, the first side wall of the second mounting bracket secured to the first side wall of the second central pedestal and the second side wall of the second mounting bracket secured to the second side wall of the second central pedestal.

15. The mounting bracket assembly of claim 11 wherein the first mounting bracket axis, when viewed in top plan view, extends orthogonally to the torque tube beam and further wherein the central wall and the first and second side walls of the first mounting bracket define a u-shaped opening which receives a first base member in a nested relationship and further wherein the second mounting bracket axis, when viewed in top plan view, extends orthogonally to the torque tube beam and further wherein the central wall and the first and second side walls of the second mounting bracket define a u-shaped opening which receives a second base member in a nested relationship.

16. A mounting bracket assembly affixed to a torque tube beam of a solar tracker assembly and supporting longitudinally extending edge portions of first and second photovoltaic modules wherein, when viewed in top plan view, the first photovoltaic module is on a first side of the torque tube beam and the second photovoltaic module is on an opposite side of the torque tube beam and the longitudinally extending edge portions of the first and second photovoltaic modules extending parallel to the torque tube beam, the mounting bracket assembly comprising:
a) a first mounting bracket coupled to the torque tube beam and extending along a first mounting bracket axis and a second mounting bracket, spaced from the first mounting bracket, coupled to the torque tube beam and extending along a second mounting bracket axis, the first and second mounting bracket axes, when viewed in top plan view, extending orthogonally to the torque tube beam, the first mounting bracket including a central wall and a first side wall extending from the central wall, the first mounting bracket including a first end portion, the first mounting bracket including a second end portion and a midpoint region between the first and second end portions, the second mounting bracket including a central wall and a first side wall extending from the central wall, the first mounting bracket having a first end portion, a second end portion and a midpoint region between the first and second end portions;
b) a first module support member including a first support arm and a second support arm, spaced from and extending parallel to the first support arm, the first support arm coupled to the central wall of the first mounting bracket at the first end portion of the first mounting bracket and coupled to the central wall of the second mounting bracket at the first end of the second mounting bracket, the second support arm coupled to the central wall of the first mounting bracket between the first end portion and the midpoint region of the first mounting bracket and coupled to the central wall of the second mounting bracket between the first end portion and the midpoint region of the second mounting bracket;
c) a second module support member including a third support arm and a fourth support arm, spaced from and extending parallel to the third support arm, the third support arm coupled to the central wall of the first mounting bracket at the second end portion of the first mounting bracket and coupled to the central wall of the second mounting bracket at the second end portion of the second mounting bracket, the fourth support arm coupled to the central wall of the first mounting bracket between the second end portion and the midpoint region of the first mounting bracket and coupled to the central wall of the second mounting bracket between the second end portion and the midpoint region of the second mounting bracket; and
d) wherein the first and second support arms are configured to support at least parts of the longitudinally extending edge portions of the first photovoltaic module and the third and fourth support arms are configured to support at least parts of the longitudinally extending edge portions of the second photovoltaic module.

17. The mounting bracket assembly of claim 16 wherein the first mounting bracket additionally includes a second side wall extending from the central wall, the base and the first and second side walls of first mounting bracket defining an inverted u-shaped opening which receives a first base member in a nested relationship and further wherein the second mounting bracket additionally includes a second side wall extending from the central wall, the central wall and the first and second side walls of second mounting bracket defining an inverted u-shaped opening which receives a second base member in a nested relationship.

18. The mounting bracket assembly of claim 16 wherein the first base member includes a lower wall and first and second side walls extending from the lower wall and the second base member includes a lower wall and first and second side walls extending from the lower wall, the first and second side walls of the first base member engaging the central wall of the first mounting bracket and the first and second side walls of the second base member engaging the central wall of the second mounting bracket.

19. The mounting bracket assembly of claim 16 further including a first set of pedestals including a first central pedestal secured to the torque tube beam including a middle portion engaging the torque tube beam and first and second extending portions on opposite sides of the torque tube beam, the first central pedestal extending along the first mounting bracket axis and including an upper wall and a lateral wall extending from the upper wall, the first side wall of the first mounting bracket secured to the first lateral wall of the first central pedestal and a second set of pedestals including a second central pedestal secured to the torque tube beam including a middle portion engaging the torque tube beam and first and end portions on opposite sides of the torque tube beam, the second central pedestal extending along the second mounting bracket axis and including an upper wall and a first lateral wall, the first side wall of the second mounting bracket secured to the first lateral wall of the second central pedestal.

20. The mounting bracket assembly of claim 16 wherein the first set of pedestals includes a first edge pedestal disposed between the first support arm of the first module support member and the first mounting bracket and a second edge pedestal disposed between the third support arm of the second module support member and the second mounting bracket and further wherein the second set of pedestals includes a third edge pedestal disposed between the first support arm of the first module support member and the second mounting bracket and a fourth edge pedestal disposed between the third support arm of the second module support member and the second mounting bracket.

21. A combination of a mounting bracket assembly and a torque tube beam of a solar tracker assembly, the mounting bracket assembly secured to the torque tube beam and supporting longitudinally extending edge portions of first and second photovoltaic modules wherein, when viewed in top plan view, the first set of photovoltaic modules are on a first side of the torque tube beam and the second set of photovoltaic modules are on an opposite side of the torque tube beam and the longitudinally extending edge portions of the first and second photovoltaic modules extend parallel to the torque tube beam, the combination comprising:
a) the torque tube beam extending along a longitudinal axis and including an upper wall and a lower wall spaced apart by first and second vertically extending side walls; and
b) the mounting bracket assembly secured to the torque tube beam and including:
i) a first mounting bracket extending along a first mounting bracket axis extending transverse to the torque tube beam, the first mounting bracket including a central wall and a first and second side walls extending from the central wall, the first mounting bracket having a first end portion, a second end portion and a central portion extending between the first and second end portions;
ii) a first set of pedestals including a first central pedestal secured to the torque tube beam including a middle portion engaging the torque tube beam and first and second extending portions on opposite sides of the torque tube beam, the first central pedestal extending along the first mounting bracket axis and including a central wall and a lateral wall extending from the central wall, at least one of the first and second side walls of the first mounting bracket secured to the lateral wall of the first central pedestal;
iii) a first module support member including a first support arm and a second support arm, spaced from and extending parallel to the first support arm, the first support arm coupled to the first mounting bracket at the first end portion of the first mounting bracket, the second support arm coupled to the first extending portion of the first central pedestal;
iv) a second module support member including a third support arm and a fourth support arm, spaced from and extending parallel to the third support arm, the third support arm coupled to the first mounting bracket at the second end portion of the first mounting bracket, the fourth support arm coupled to the second extending portion of the first central pedestal; and
v) wherein the first and second support arms are configured to support the longitudinally extending edge portions of the first photovoltaic module and the third and fourth support arms are configured to support the longitudinally extending edge portions of the second photovoltaic module.
